(19) United States
(12) Patent Application Publication
(10) Pub. No.: US 2015/0278758 A1
(43) Pub. Date: Oct. 1, 2015

(54) METHOD AND SYSTEM FOR A SHIPMENT COORDINATION SERVICE

(71) Applicants: Jong Myoung KIM, Yorba Linda, CA (US); Jason KIM, Yorba Linda, CA (US)

(72) Inventors: Jong Myoung KIM, Yorba Linda, CA (US); Jason KIM, Yorba Linda, CA (US)

(21) Appl. No.: 14/225,255

(22) Filed: Mar. 25, 2014

(51) Int. Cl. G06Q 10/08

(52) U.S. Cl. CPC G06Q 10/08355

(57) ABSTRACT

A shipment coordination service, which may be a company or a business, coordinates shipment of a package between an origin and a destination using one or more carriers. The shipment coordination service may have one or more processing centers associated with it for processing packages. The shipment coordination service can use an origin carrier to deliver the package from an origin to an origin processing center, and a destination carrier can deliver the package from a destination processing center or another intermediate location to the destination. The shipment coordination service may also use an intermediate carrier to deliver the package from one processing center to another processing center or to another intermediate location.

### BACKGROUND

The present disclosure generally relates to coordinating the shipment of packages. A traditional carrier (e.g., UPS, FedEx, DHL, etc.) ships packages primarily using its own network of resources. For example, in order to ship a package from origin to destination, UPS collects the package from an origin location and delivers the package using its own fleet of vehicles and/or planes. The package may pass through one or more UPS sites before delivering the package to the final destination.

### SUMMARY

The disclosure teaches systems and methods of coordinating and processing the shipment of a package by a business between an origin and a destination. In one embodiment, the method includes providing a data store comprising geographical area data store entries associated with a plurality of predetermined geographical areas and carrier data store entries associated with a plurality of carriers; providing a user interface on a computing device for a customer to conduct a transaction for shipment of a package from an origin to a destination; and receiving shipment information from the customer through the user interface, wherein the shipment information comprises an origin and a destination. The method also includes identifying a first predetermined geographical area encompassing the origin, wherein the first predetermined geographical area is one of the plurality of predetermined geographical areas; identifying an origin processing center associated with the identified first predetermined geographical area; and identifying a second predetermined geographical area encompassing the destination, wherein the second predetermined geographical area is one of the plurality of predetermined geographical areas.

The method also includes determining a shipment route from the origin to the destination that includes an origin shipment segment for delivery of the shipment from the origin to an origin processing center; at least one intermediate shipment segment for delivery of the shipment from the origin processing center to an intermediate destination, and a destination shipment segment for delivery of the shipment from the intermediate destination to the destination. The method also includes selecting an origin carrier for the origin shipment segment, wherein the origin carrier is selected from a first group of carriers that are associated with the first predetermined geographical area based, at least in part, on the shipment information received from the customer. The method also includes selecting a destination carrier for the destination shipment segment, wherein the destination carrier is selected from a second group of carriers that are associated with the second predetermined geographical area based, at least in part, on the shipment information received from the customer. The intermediate location can be a destination area processing center.

The method also includes assigning an origin carrier identification code associated with the origin carrier to the origin shipment segment such that the origin carrier uses the origin carrier identification code to identify the package for the origin shipment segment; assigning an destination carrier identification code associated with the destination carrier to the origin shipment segment such that the destination carrier uses the destination carrier identification code to identify the package for the destination shipment segment; and assigning a shipment identification code for the transaction for shipment of the package from the origin to the destination.

The method also includes generating a label for attaching onto the package that includes a shipment information portion including the shipment identification code, an origin shipment portion for use by the origin carrier during the origin shipment segment including the origin carrier identification code and an address of the origin area processing center as a destination of the origin shipment segment for the origin carrier; and destination shipment information for use by the destination carrier during the destination shipment segment including the destination carrier identification code and an address for the destination. The label can be generated substantially in real-time during the transaction. For example, the label can be generated after the request for the generation has been received by the system, taking into account factors that affect the amount of time that is actually required to perform the label generation, such as computing processing time, latency, and other parameters.

In some embodiments, the method includes creating a shipment data store entry for the transaction, the shipment data store entry comprising the shipment identification code, the origin carrier identification code, the destination carrier identification code, information indicative of the origin carrier, and information indicative of the destination carrier. In some embodiments, the method further comprises obtaining at least one intermediate tracking code associated with the shipment between the origin area and the destination area. In some embodiments, the method further comprises formulating details of the shipment of the package from the origin to the destination; and sending the details to the computing device for presenting to the customer using the user interface. In some embodiments, a plurality of steps among identifying a first predetermined geographical area, identifying an origin processing center, identifying a second predetermined geographical area, determining a shipment route, selecting an origin carrier, selecting a destination carrier, assigning an origin carrier identification code, assigning an destination carrier identification code, assigning a shipment identification code, generating a label, formulating details and sending the details are performed real time while the customer is conducting the transaction using the user interface.

In some embodiments, the method includes receiving a request, from a user, for a status update of the shipment of the package, the request comprising the shipment identification code and identifying the origin carrier identification code and the destination carrier identification code based on the shipment identification code. Based on a current status of the shipment, performing at least one of the following: communicating with the origin carrier to request an origin carrier shipment status using the origin carrier identification code; communicating with the processing center to request a processing center shipment status using the shipment identification code; and communicating with the destination carrier to request a destination carrier shipment status using the destination carrier identification code. The method also includes providing the status update to the user comprising information from at least one of the origin carrier shipment status, the processing center shipment status, and the destination shipment status.

In some embodiments, the origin carrier is operated by a first entity, the processing center is operated by a second entity, and the destination carrier is operated by a third entity. The origin carrier and the destination carrier may be the same. At least one of the first group of carriers and the second group of carriers comprises two or more carriers.

In some embodiments, the origin is in a first country and the destination is in a second country, and wherein determining the shipment route from the origin to the destination further comprises determining a third country for the shipment route based on the second country, wherein the intermediate destination is the third country.

In some embodiments, before or at completion of the transaction, providing the customer with an identity of the origin carrier, the label for the customer or an agent of the origin carrier to print for the package, and instructions for transferring the package to the origin carrier, wherein when the package is to be picked up, the instructions specify time and the pick-up location along with the identity of the origin carrier, wherein when the package is to be dropped off, the instructions provide the identity of the origin carrier and one or more drop-off locations for the origin carrier.

In an illustrative embodiment of a system for coordinating and processing shipment of a package between an origin to a destination, the system includes a data store comprising geographical area data store entries associated with a plurality of predetermined geographical areas, carrier data store entries associated with a plurality of carriers, and shipment data store entries associated with shipment transactions; and a shipment coordination system in communication with the data store. The shipment coordination system comprising a hardware computing device with executable instructions configured to receive shipment information comprising an origin and a destination and identify a first predetermined geographical area based, at least in part, on the origin, wherein the first predetermined geographical area is one of the plurality of predetermined geographical areas, an origin processing center is associated with the first predetermined geographical area. The system further configured to identify a second predetermined geographical area based, at least in part, on the destination, the second predetermined geographical area is one of the plurality of predetermined geographical areas.

The system further configured to determine a shipment route from the origin to the destination that includes an origin shipment segment for delivery of the shipment from the origin to an origin processing center; at least one intermediate shipment segment for delivery of the shipment from the origin processing center to an intermediate destination, and a destination shipment segment for delivery of the shipment from the intermediate destination to the destination.

The system further configured to select an origin carrier for the origin shipment segment, wherein the origin carrier is selected from a first group of carriers associated with the first predetermined geographical area based, at least in part, on the shipment information; and select a destination carrier for the destination shipment segment, wherein the destination carrier is selected from a second group of carriers associated with the second predetermined geographical area based, at least in part, on the shipment information.

The system further configured to assign an origin carrier identification code associated with the origin carrier to the origin shipment segment such that the origin carrier uses the origin carrier identification code to identify the package for the origin shipment segment; assign an destination carrier identification code associated with the destination carrier to the origin shipment segment such that the destination carrier uses the destination carrier identification code to identify the package for the destination shipment segment; and assign a shipment identification code for the transaction for shipment of the package from the origin to the destination.

The system further configured to generate a label for attaching onto the package, the label comprising, a shipment information portion including the shipment identification code; an origin shipment portion for use by the origin carrier during the origin shipment segment including the origin carrier identification code and an address of the origin area processing center as a destination of the origin shipment segment for the origin carrier; and destination shipment information for use by the destination carrier during the destination shipment segment including the destination carrier identification code and an address for the destination.

In some embodiment the system is further configured to create a shipment database entry for the transaction, the data store entry comprising the shipment identification code, the origin carrier identification code, the destination carrier identification code, information indicative of the origin carrier, and information indicative of the destination carrier. the shipment coordination system is configured to execute a plurality of instruction configured to identify a first predetermined geographical area, identify an origin processing center, identify a second predetermined geographical area, determine a shipment route, select an origin carrier, select a destination carrier, assign an origin carrier identification code, assign an destination carrier identification code, assign a shipment identification code, generate a label.

In some embodiment, the system is further configured to receive a request, from a user, for a status update of the shipment of the package, the request comprising the shipment identification code; identify the origin carrier identification code and the destination carrier identification code based on the shipment identification code. Based on a current status of the shipment, performing at least one of the following communicate with the origin carrier to request an origin carrier shipment status using the origin carrier identification code; communicate with the processing center to request a processing center shipment status using the shipment identification code; communicate with the destination carrier to request a destination carrier shipment status using the destination carrier identification code. The system also can provide the status update to the user comprising information from at least one of the origin carrier shipment status, the processing center shipment status, and the destination shipment status. The process of tracking and providing the status update can be performed in substantially real-time. For example, the tracking can be performed after the tracking request has been received by the system, taking into account factors that affect the amount of time that is actually required to interface with the associated tracking interfaces, such as computing processing time, latency, connectivity, and other parameters.

In some embodiments, the shipment coordination system and the processing center are operated by the same entity, which is a different entity than the origin carrier and the destination carrier. The shipment information can include package type, package weight, package size, package value, service type, and customs infoimation.

In some embodiments, the origin is in a first country and the destination is a second country, and wherein the shipment coordination service is further configured to determine a third country that the packaged is to be shipped through for at least one of the intermediate shipment segments based, at least in part, on the second country. At least one of the first group of carriers and the second group of carriers comprises two or more carriers. The shipment identification code is used by the origin processing center for identifying the package at the origin processing center. Each of the plurality of predetermined geographic areas are defined by at least one of a country, state, city, county or arbitrary boundary.

In an illustrative embodiment of a method of coordinating and processing an international shipment of a package between an origin to a destination, the method includes providing a data store comprising geographical area data store entries associated with a plurality of predetermined geographical areas and carrier data store entries associated with a plurality of carriers; and providing a user interface on a computing device for a customer to conduct a transaction for shipment of a package from an origin to a destination. The method also includes receiving shipment information from the customer through the user interface, wherein the shipment information comprises an origin in a first country and a destination in a second country. The method also includes identifying a first predetermined geographical area encompassing the origin, wherein the first predetermined geographical area is one of the plurality of predetermined geographical areas; identifying an origin processing center associated with the identified first predetermined geographical area; and identifying a second predetermined geographical area encompassing the destination, wherein the second predetermined geographical area is one of the plurality of predetermined geographical areas.

The method also includes determining a shipment route from the origin to the destination that includes an origin shipment segment for delivery of the shipment from the origin to an origin processing center; at least one intermediate shipment segment for delivery of the shipment from the origin processing center to an intermediate destination in a third country, and a destination shipment segment for delivery of the shipment from the intermediate destination in the third country to the destination. The identification of the third country can be determined based, at least in part, on the second country.

The method also includes selecting an origin carrier for the origin shipment segment, wherein the origin carrier is selected from a first group of carriers that are associated with the first predetermined geographical area based, at least in part, on the shipment information received from the customer; assigning an origin carrier identification code associated with the origin carrier to the origin shipment segment such that the origin carrier uses the origin carrier identification code to identify the package for the origin shipment segment; and assigning a shipment identification code for the transaction for shipment of the package from the origin to the destination.

The method also includes generating a label for attaching onto the package that includes a shipment information portion including the shipment identification code and an address for the destination; and an origin shipment portion for use by the origin carrier during the origin shipment segment including the origin carrier identification code and an address of the origin area processing center as a destination of the origin shipment segment for the origin carrier.

In some embodiments, the method includes identifying an international carrier for delivering the package from the intermediate destination in the third country to the destination in the second country. The method can also include creating a shipment data store entry for the transaction, the shipment data store entry comprising the shipment identification code, the origin carrier identification code, information indicative of the origin carrier, and information indicative of an international carrier. In some embodiments, the method also includes formulating details of the shipment of the package from the origin to the destination; and sending the details to the computing device for presenting to the customer using the user interface. In some embodiments, wherein a plurality of steps among identifying a first predetermined geographical area, identifying an origin processing center, identifying a second predetermined geographical area, determining a shipment route, selecting an origin carrier, assigning an origin carrier identification code, assigning a shipment identification code, generating a label, formulating details and sending the details are performed real time while the customer is conducting the transaction using the user interface.

In some embodiments, the identity of the origin carrier is unavailable to the customer until the information of the origin carrier is provided with the instructions or until information contained in the label is provided to the customer. In some embodiments preparing and sending to the origin carrier electronic instructions with information of the origin shipment comprising the origin carrier tracking code so that the origin carrier identifies the package and completes the origin shipment from the origin to the origin area processing center of said business. The company operating the shipment coordination service is not necessarily run by said business or of the business' property.

In an illustrative embodiment of a method and system of coordinating and processing a long-distance shipment of a package by a business using one or more carriers other than said business, the method includes a) providing a long-distance shipment processing system for shipment of a package from an origin located within a first predetermined geographical area to a destination located within a second predetermined geographical area, the origin being a pick-up location of the package or a drop-off location of the package for the shipment to the destination.

The system includes a database comprising geographical area database entries and carrier database entries, the geographical area database entries being associated with a plurality of predetermined geographical areas comprising the first and second predetermined geographical areas, the carrier database entries being associated with a plurality of predetermined carriers for at least part of the plurality of predetermined geographical areas, the carrier database entries comprising a first group of plurality carriers for the first predetermined geographical area and a second group of plurality carriers for the second predetermined geographical area. The system also includes a user interface configured to be displayed on a computing device, the user interface comprising one or more pages for a customer to interact with the system. The system also includes an origin processing center located in the first predetermined geographical area, the origin processing center configured to receive delivery of the package by a carrier other than the business, which is coordinated by the business and further to process the package for further shipment toward the destination by a carrier other than the business, which is coordinated by the business.

The method can also include b) conducting a transaction for the shipment via the user interface and using the database, wherein conducting the transaction including receiving an address or geographical information of the origin from the customer through the user interface, searching in the database for an area encompassing the origin (origin area) from the plurality of predetermined geographical areas using the address or geographical information of the origin submitted from the customer, wherein searching determines that the first predetermined geographical area encompasses the origin.

The method also includes receiving at least one of size information and weight information of the package submitted by the customer through the user interface; and selecting a carrier for the origin area (origin carrier) from the first group of plurality carriers that are associated with the first predetermined geographical area using the at least one of size information and weight information of the package, wherein the origin carrier is in charge of the shipment of the package from the origin to an origin area processing center of said business within the origin area (origin shipment). The method also includes receiving an address of the destination (destination address) from the customer through the user interface, and searching in the database for an area encompassing the destination (destination area) from the plurality of predetermined geographical areas using the destination address submitted from the customer, wherein the second predetermined geographical area is identified as encompassing the destination.

The method can also include selecting a carrier for the destination area (destination carrier) from the second group of plurality carriers that are associated with the second predetermined geographical area using the at least one of size information and weight information of the package, wherein the destination carrier is in charge of the shipment of the package from a predetermined location within the destination area to the destination (destination shipment). The location within the destination area can includes a destination area processing center. The method can also include coordinating a shipment of the package from the origin to the processing center (origin shipment) using an origin carrier other than the business; coordinating a shipment of the package from the processing center to the destination (destination shipment) using an destination carrier other than the business; and obtaining a unique identification code assigned by the origin carrier and associated with the origin shipment (origin carrier tracking code) such that the origin carrier uses the origin carrier tracking code to identify the package for the original shipment from the origin to the origin area processing center. The codes can be assigned at the time of delivery or pre-assigned. The method can also include obtaining a unique identification code assigned by the destination carrier and associated with the destination shipment (destination carrier tracking code) such that the destination carrier uses the destination carrier tracking code to identify the package for the destination shipment from the predetermined location within the destination area to the destination.

The method can also include generating a unique transaction identification code for the transaction and for the shipment from the origin to the destination (overall shipment tracking code); and creating a database entry for the transaction with the customer, the database entry comprising the overall shipment tracking code, the origin carrier tracking code, the destination carrier tracking code, information indicative of the origin carrier, and information indicative of the destination carrier.

The method can also include, before or at completion of the transaction, generating a label for attaching onto the package, the label comprising origin shipment information for the origin carrier and destination shipment information for the destination carrier, the origin shipment information comprising the origin carrier tracking code and an address of the origin area processing center as a destination of the origin shipment for the origin carrier, the destination shipment information comprising the destination carrier tracking information and the destination address; In some embodiments, the origin area processing center is not associated with the origin carrier.

The method can also include, before or at completion of the transaction, providing the customer with an identity of the origin carrier, the label for the customer or an agent of the origin carrier to print for the package, and instructions for transferring the package to the origin carrier, wherein when the package is to be picked up, the instructions specify time and the pick-up location along with the identity of the origin carrier, wherein when the package is to be dropped off, the instructions provide the identity of the origin carrier and one or more drop-off locations for the origin carrier. The identity of the origin carrier can be unavailable to the customer until the information of the origin carrier is provided with the instructions or until information contained in the label is provided to the customer.

The method can also include preparing and sending to the origin carrier electronic instructions with information of the origin shipment comprising the origin carrier tracking code so that the origin carrier identifies the package and completes the origin shipment from the origin to the origin area processing center of said business. The origin carrier is not necessarily run by said business or of the business' property.

The processing center can be configured to receive the package from the origin carrier and additional packages from one or more other carriers of the first group of plurality of carriers, wherein each of the additional packages comprises a label attached thereon, which contains a unique identification code assigned by another carrier of the first group and associated with shipment of the additional package from a location within the origin area to the origin area processing center.

The processing center can process information contained in the label to identify the package and the destination area of the package. The processing center can place a new label on the package. The processing center can group the package along with one or more other packages that are being shipped to one or more destinations within the destination area, wherein each of the other packages comprises a label attached thereon, which contains a unique identification code assigned by another carrier of the second group of plurality of carriers and associated with shipment of the other package from the predetermined location to a location within the destination area.

The processing center can transfer the package along with the one or more other packages to an intermediate carrier in charge of shipment at least in part between the origin area and the destination area such that the package is to be shipped the destination area and further transferred to the destination carrier at the predetermined location in the destination area for the destination shipment by the destination carrier. The processing center can select a carrier for the intermediate shipment.

In some embodiments, the origin carrier is not the same entity as the business coordinating and processing the shipment. The origin carrier and the destination carrier can be different entities than the business. The origin carrier and the destination carrier can be the same entity. In such instances, the origin tracking number is different from the destination tracking number. In some embodiments when the origin carrier and the destination carrier are the same entity, the transaction for the origin shipment is independent from the transaction for the destination shipment.

In some embodiments when completing the transaction, an intermediate carrier for shipping the package between the origin area processing center and the location within the destination area has not been determined. The system can determine the intermediate carrier after processing at the origin area processing center.

In some embodiments, the label further comprises a unique identification information code for the processing center, wherein identifying the package at the processing center utilizes the unique identification code for the processing center contained in the label to identifying the package.

In some embodiments, the processing center can examine the package to determine that size and weight of the package are consistent with the information included in the request. The processing center can use palleting for shipment of the package with other packages. The processing center can group packages by destination countries. The processing center can group packages by destination carriers within the destination country. The processing center can send a package to an intermediate country other than the destination country.

In some embodiments, the label is in the form of a single integrated sheet containing the origin carrier shipping information, the intermediate carrier shipping information, and the destination carrier shipping information. In some embodiments, the label includes two or more separate sheets, which in combination contain the origin carrier shipping information, and the intermediate carrier shipping information, the destination carrier shipping information.

In some embodiments, the predetermined geographical areas can be a country, state, city, county, or an arbitrary boundary. The predetermined geographical areas can be predetermined and stored in a data store. The predetermined geographical areas can have at least one port, airport or train station. At least some of the predetermined geographical areas can have a processing center.

### BRIEF DESCRIPTION OF THE DRAWINGS

The foregoing and other features, aspects, and advantages of the present invention are described in detail below with reference to the drawings of various embodiments, which are intended to illustrate and not to limit the invention. The drawings comprise the following figures in which:

FIGS. 1A and 1B illustrate a process for shipping packages using a plurality of carriers according to certain aspects of the invention.

FIG. 2A illustrates an embodiment of a country divided into a plurality geographic areas.

FIG. 2B illustrates an embodiment of data stored in a geographic area data store.

FIG. 3 provides an overview of shipping packages using a plurality of carriers according to one embodiment of the invention.

FIG. 4A illustrates an embodiment of a computing environment for a shipping service.

FIG. 4B illustrates an embodiment of data stored in a shipment data store.

FIG. 4C illustrates an embodiment of data stored in a package data store.

FIG. 5 provides a block diagram illustrating a process of coordinating and processing the shipment of a package between an origin and a destination using a plurality of carriers.

FIGS. 6A-6E illustrate embodiments of user interfaces of a shipment coordination service.

FIGS. 7A-7C illustrate embodiments of labels for shipping packages using a shipment coordination service.

FIG. 8 provides a flowchart for shipping packages using a plurality of carriers.

FIG. 9 provides a flowchart for an embodiment of a process for processing packages at a processing center.

FIG. 10 provides a flowchart for an embodiment of a process for shipping a package internationally.

FIG. 11 provides a flowchart for an embodiment of tracking a shipment that uses a plurality of carriers.

FIG. 12 provides a flowchart for shipping packages using an electronic label.

### DETAILED DESCRIPTION OF EMBODIMENTS

Embodiments of the invention will now be described with reference to the accompanying figures. The terminology used in the description presented herein is not intended to be interpreted in any limited or restrictive manner, simply because it is being utilized in conjunction with a detailed description of certain specific embodiments of the invention. Furthermore, embodiments of the invention may comprise several novel features, no single one of which is solely responsible for its desirable attributes or which is essential to practicing the inventions herein described.

### Shipment Coordination Service

According to certain aspects of this disclosure, a shipment coordination service, which may be a company or a business, coordinates shipment of a package between an origin and a destination using one or more carriers. The shipment coordination service may have one or more processing centers associated with it for processing packages. The shipment coordination service can use an origin carrier to deliver the package from an origin to an origin processing center, and a destination carrier can deliver the package from a destination processing center or another intermediate location to the destination. The shipment coordination service may also use an intermediate carrier to deliver the package from one processing center to another processing center or to another intermediate location.

### User Interface

The shipment coordination service can provide a user interface for a customer to place an order to ship a package. The user interface can provide an interface through which a customer can enter information such as: origin address or location, destination address, level of service (e.g., express, regular, etc.), package information (e.g., weight, size, etc.), etc. Based on the customer input, such as the origin address, the shipment coordination service can determine an origin carrier that will deliver the package from the origin to a processing center. Similarly, based on the customer input, such as the destination address, the shipment coordination service can determine a destination carrier that will deliver the package to the destination from a processing center or another intermediate location.

### Carrier Database(s)

The shipment coordination service may provide a unique tracking code for the transaction that can be used to track the shipment of the package from the origin to the destination. The shipment coordination service can have a database that includes information about carriers associated with various geographical areas. The origin carrier and the destination carrier may be selected from the list of carriers associated with their respective relevant geographical areas. The origin carrier and the destination carrier can be selected automatically by the shipment coordination service, for example, based on the information provided by the customer.

### Label

The shipment coordination service can generate a label that includes shipment information relating to the origin carrier, the destination carrier and a processing center. For example, the label can include shipment information recognized by the origin carrier, shipment information recognized by the destination carrier, and shipment information recognized by the processing center. The shipment information may be in the form of a barcode, a QR code, a number, an alphanumeric sequence, a combination of different codes, and/or other shipment identifier. The origin carrier shipment information can indicate a processing center as the destination for the delivery of the package from the origin by the origin carrier.

In some embodiments, the customer can print the label to attach onto the package. After the transaction for shipment is complete, the customer can drop off the package to a location of the origin carrier (e.g., store) or have the origin carrier pick up the package at a particular location (e.g., the customer's home). The origin carrier delivers the package to the processing center designated in the origin carrier shipment information on the label.

### Processing Center

When the package is received at the processing center, the processing center can process the package based on the information included in the label. The processing center may receive packages delivered by a number of different origin carriers. The received packages may be processed to verify weight and/or size, and can be grouped according to destinations. For example, packages destined for a particular region, such as a foreign country may be grouped together. After the received packages are processed, the processing center can transfer the grouped packages to an intermediate carrier that can deliver the packages to another processing center or an intermediate location.

When the packages are received at the destination processing center or at an intermediate location, the packages can be transferred to the destination carrier. The destination carrier can deliver the packages to their respective destinations.

In this manner, the shipment coordination service can utilize resources of one or more carriers other than itself to deliver a package from any location to any destination. The company can select one or more carriers based on the customer input. The company can optimize selection of the combination according to requirements of the customer. For example, if the customer wants to send a package as quickly as possible, the company can select a combination of origin carrier and destination carrier that can deliver the package in the shortest amount of time. If the customer wants to send a package at the lowest cost possible, the company can provide a combination of origin carrier and destination carrier that offers the lowest rates for the delivery. The shipment coordination service allows the customer to keep track of the entire delivery process without having to check the status of package at each carrier individually.

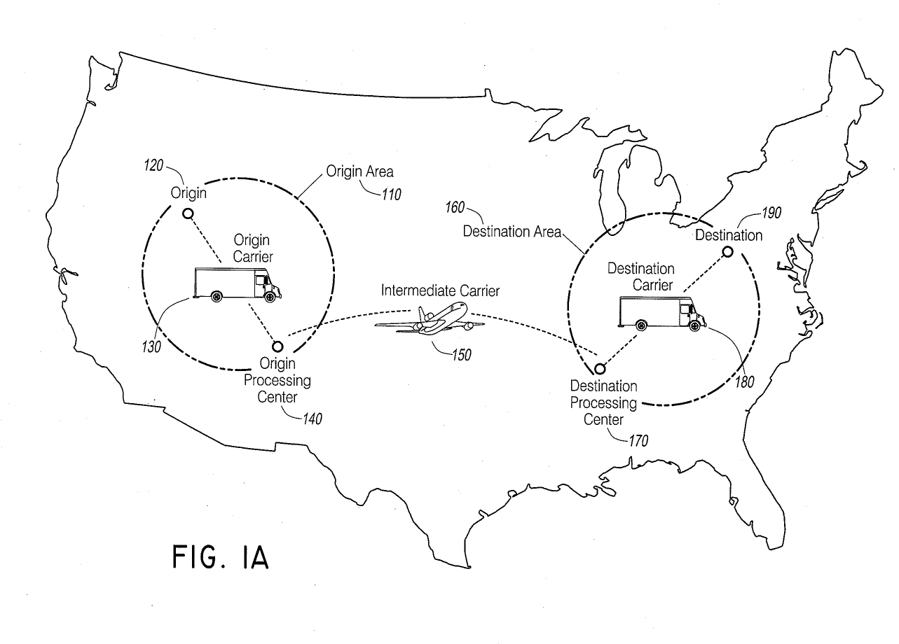

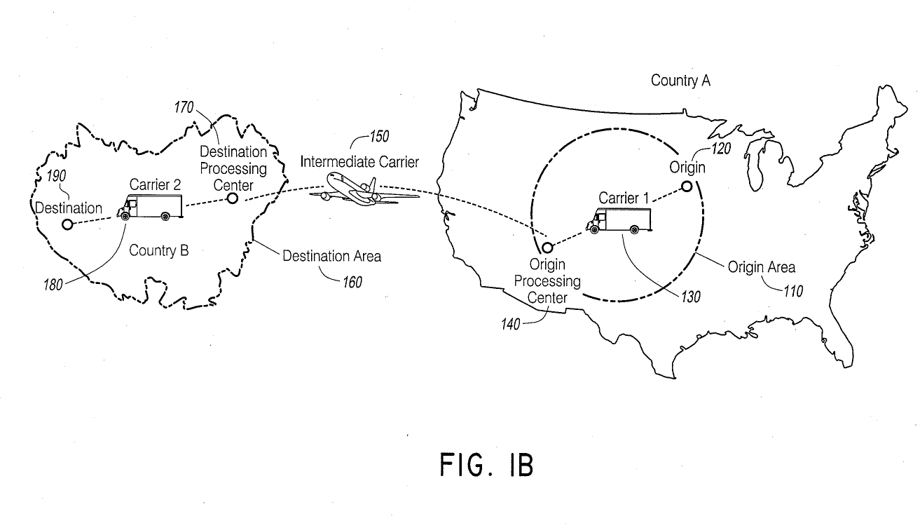

FIG. 1A illustrates an embodiment of a shipment coordination service for shipping packages using a plurality of carriers. The shipment coordination service may coordinate and oversee the shipment of a package from an origin 120 to a destination 190 in multiple segments handled by the plurality of carriers other than the entity operating the shipment coordination service. The shipment coordination service may utilize one or more processing centers 140, 170 that can receive and ship packages. In some embodiments, the processing center(s) may be operated by the same entity that operates the shipment coordination service. In some embodiments, the entity operating the shipment coordination service does not operate the processing centers. The shipment coordination service may use a carrier other than the company that operates the shipment coordination service to deliver the package from the origin 120 to an origin processing center 140. The shipment coordination service may also use a carrier other than the company operating the shipment coordination service to deliver the package to the destination 190.

### Domestic Shipping

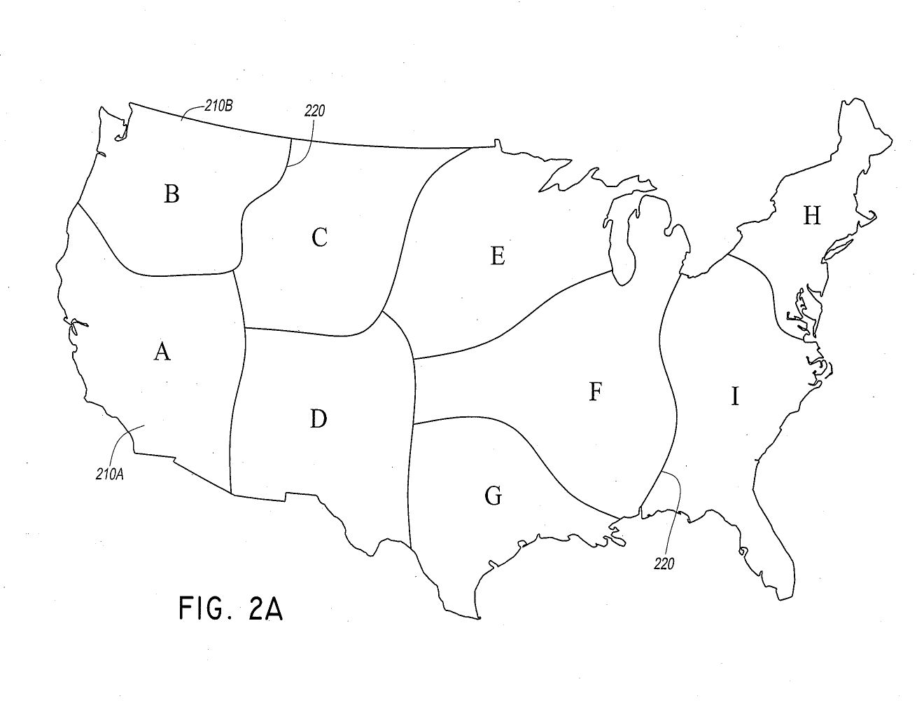

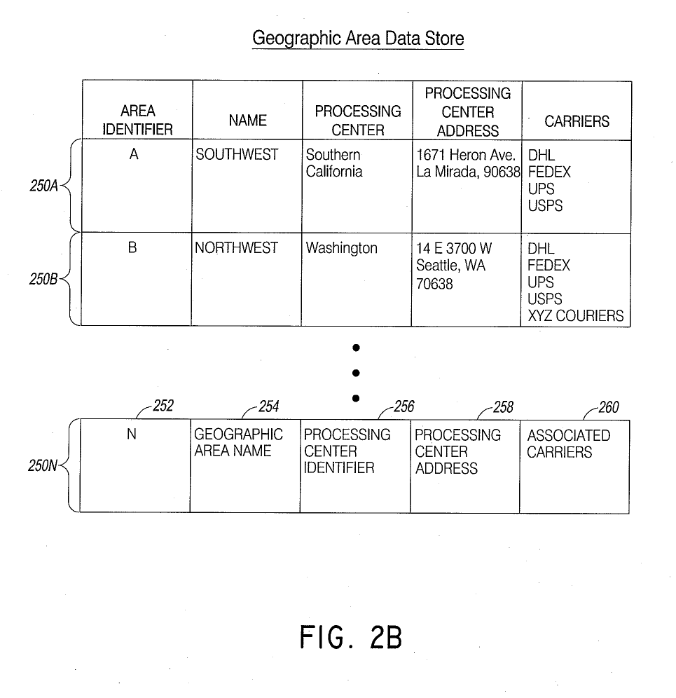

With continued reference to FIG. 1A, an instance of shipping a package domestically within the United States is illustrated. In this embodiment, the shipment coordination service coordinates shipping a package from an origin 120 within the U.S. to a destination 190 within the U.S. The origin 120 is within an origin area 110 and the destination 190 is within a destination area 160. The origin area 110 and destination area 160 can represent predetermined geographical areas that are defined by the shipment coordination service. The shipment coordination service can define multiple predetermined geographical areas within a larger geographical area in order to facilitate shipment. For example, the company can subdivide parts of a country into predetermined geographical areas for service, which is further illustrated in FIGS. 2A and 2B. FIG. 1A illustrates at least two predetermined geographic areas (the origin area 110 and the destination area 160), but any number of predetermined geographic areas can be defined. In some embodiments, the predetermined geographic areas can overlap. In this embodiment, both the origin area 110 and the destination area 160 are located within the same country.

An origin carrier can refer to a carrier that is in charge of the segment of the shipment of the package from the origin 120 to a processing center 140. The portion of the shipment from the origin 120 to the processing center 140 handled by the origin carrier 130 can be referred to as the origin shipment.

The origin area 110 includes a processing center 140 that can be associated with the shipment coordination service, which can be referred to as an origin processing center or origin area processing center. In this embodiment, the shipment between the origin 120 and the origin processing center 140 is an intra-area shipment. The destination area 160 includes another processing center 170 that can be associated with the shipment coordination service, also referred to as destination processing center or destination area processing center. The package can be delivered from the origin 120 to the origin processing center 140 by an origin carrier within the origin area 110.

The package can be received and processed at the processing center 140. The package can be delivered from the processing center 140 in the origin area 110 to the processing center 170 in the destination area 150 by an intermediate carrier 150. The intermediate shipment can be an inter-area shipment. In some embodiments, the processing centers can be located at, or in close proximity to airports or other locations capable of delivering packages via air carriers. In some embodiments, the package may be delivered to an intermediate processing area 170 in the destination area 160. Subsequently, the package can be delivered from the destination processing center 170 to the destination 190 by a destination carrier 180 in the destination area 160.

### International Shipping

FIG. 1B illustrates an embodiment of shipping packages between countries using one or more carriers. The origin 120 is located within Country A (e.g., the U.S.) and the destination 190 is located within Country B that is outside of country A. The origin area 110 includes the origin 120, and the destination area 160 includes the destination 190. The destination area 160 is defined to include the entire Country B. The origin area 110 in Country A includes a processing center 140. The destination area 160, Country B, can include another processing center 170. The package can be delivered from the origin 120 to the origin processing center 140 by the carrier 130 in the origin area 110 in Country A. The package can be delivered between the origin area 110 and the destination area 160 in Country B by an intermediate carrier. If there is a destination processing center 170 in the destination area 160 within Country B, the package can be delivered to the destination processing center 170. Subsequently, the package can be delivered to the destination 190 by carrier 180 within the destination area 160.

### Predetermined Geographic Areas

FIG. 2A is an illustrative example of a country divided into a plurality of geographic areas. The country (e.g., the United States) has a plurality of regions 210A-H that are divided by area boundaries 220. The geographical area can be defined and stored within a shipment coordination service as appropriate. For example, the geographic area can be a country, a state, a city, a county, a region or any other area defined by an arbitrary area boundary. The geographic area can be predetermined or predefined. For example, the geographic areas can be determined prior to a customer conducting a transaction for a shipment of a package. In some embodiments, the geographic area can include an airport, a processing center, both, neither or a plurality of each. Processing centers are described in more detail below. A region, such as a country, can be divided up into any number of geographic areas. In this embodiment, the U.S. is divided into nine defined areas.

### Geographic Area Data Store

FIG. 2B provides an illustrative example of an embodiment of data stored in a geographic area data store. The data store includes a plurality of data sets 250A-N. The data sets 250A and 250B illustrate instances of data associated with areas 210A and 210B. The data set 250N illustrates the type of information stored within a data set. In this embodiment, the information stored in each data set includes a geographical area identifier 252, a geographical area name 254, a processing center identifier 256, a processing center address 258, and carriers associated with the geographical area 260. Other embodiments of the data store can include more or fewer data entries than those illustrated in this embodiment.

Though not illustrated here, the data sets for each defined geographical area can include information delineating the specific area boundaries associated with each geographical area. For example, the information could include a list of cities, counties, states, or other information that is used to define the specifics of the geographical area. In some embodiments, the geographical area could use more specific coordinate information, such as GPS, to define the area boundaries.

The geographic area identifier 252 can be any identifier that can be used to identify the area. The geographic area identifier 252 can be an alphanumeric identifier or combination of alphanumeric characters that identifies the area. The identifier can be relative to all identifiers stored for a specific region, such as, for example, a state, country or continent, or the identifier could be an absolute, such that it identifies the area with respect to the entire world. The region name 254 can be a name associated the geographic area.

The processing center identifier 256 identifies the processing center located within the geographic area. In some embodiments, the geographic areas can be determined based on the location of the processing centers. For example, the geographic areas could be defined so that there is only one processing center per geographic area. In some embodiments, there can be more than one processing center per geographic area and the data store can include data entries that identify each processing center with the geographic area.

A geographic area can have one or more associated carriers 260. For example, the region 210A can be associated with a plurality of carriers and the region 210B can be associated with a plurality of carriers, which can include carriers that are the same and/or different. The identified carriers can be used as origin, intermediate and/or destination carriers to deliver a package to an address within the geographic area.

### Shipment Processing Overview

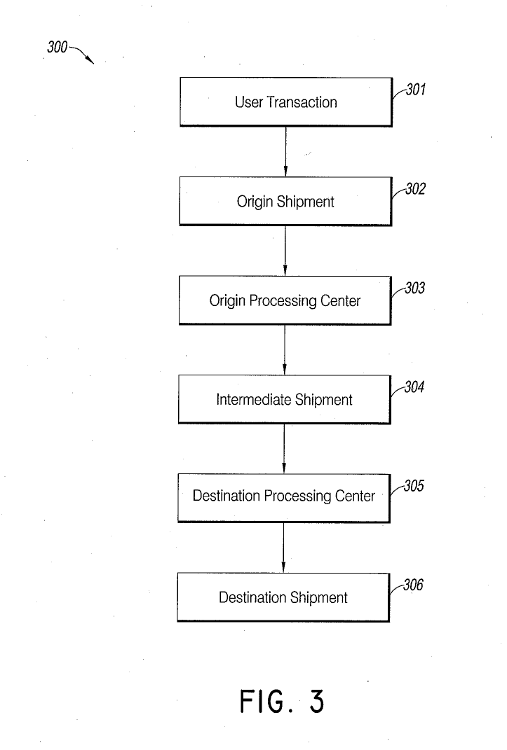

FIG. 3 illustrates an embodiment of a process 300 for shipping packages using one or more other carriers. In the process 300, a shipment coordination service coordinates a shipment of a package from an origin to a destination having a route with multiple segments or legs. Each segment can be associated with a different carrier where one or more carriers are not associated with the shipment coordination service. In some embodiments, one or more blocks or steps in the process can be added or removed.

At block 301, a user conducts a transaction with the company for shipment of a package from an origin to a destination. The user conducts the transaction using a user interface provided by the shipment coordination service. During the user transaction, the shipment coordination service can determine a package route. The package route can be defined by the origin, the destination, and one or more intermediate destinations. The package route can further define each of the intermediate travel segments between the origin and destination. Each travel segment can have a plurality of segment parameters or characteristics, such as a start point, an end point, an associated carrier, a carrier type and other parameters. In some embodiments, the shipment coordination service determines each intermediate destination, and all the parameters associated with each segment. In some embodiments, the shipment coordination service determines a portion of the route and/or a subset of the travel characteristics associated with each subset. For example, in some embodiments, the shipment coordination service may determine a route and intermediate destinations but not every carrier associated with each segment.

At block 302, a first carrier determined by the shipment coordination service ships the package from the origin to a processing center within the origin area, also referred to as an origin processing center. The origin processing center can be associated with the same entity as the shipment coordination service and the first carrier can be associated with a different entity. This segment of the route can be referred to as the origin shipment. This shipment can be an intra-area shipment where the origin and the processing center are located within the same predetermined geographic area. The shipment coordination service coordinates the origin shipment with the first carrier, which can also be referred to as the origin carrier. The first carrier ships the package based on instructions and/or information from the shipment coordination service.

At block 303, the package is received at the origin processing center. The processing center processes the package based on instructions and/or information from the shipment coordination service. The processing center can be associated with the same entity as the shipment coordination service. In some embodiments, the processing center adds a label to the package that includes the final destination and one or more intermediate destinations. The processing center can process the package so that it is shipped in bulk with other packages with similar destination areas. For example, the processing center can include the package in a pallet with other packages that are heading to the same destination processing center. The origin processing center can receive packages from one or more carriers that are not associated with the processing center or the shipment coordination service.

At block 304, the package is from the origin area to the destination area by an intermediate carrier. The package can be shipped in bulk with other packages. The intermediate carrier can transport the package by air, land (truck, rail, etc.) or sea. As illustrated in FIG. 2, the destination area can be in a different country than the origin area. The package can be delivered from the origin processing center to a location for transportation by the carrier (e.g., an airport serviced by an air carrier). The intermediate carrier can be an inter-area shipment that ships the package from the origin area to the destination area. This segment of the shipment may be referred to as the intermediate shipment.

At block 305, the shipment including the package is received at a processing center in the destination area or an intermediate processing area. The shipment can be a bulk shipment including the package and a plurality of other packages. The processing center can collect the shipment including the package from a delivery location (e.g. a dock or airport) and deliver the shipment to the destination processing center. At the destination processing center the shipment is processed and the package is routed to its final destination in accordance with instructions received from the package label and/or instructions received from the shipment coordination service. In some embodiments, the destination processing center is associated with the same entity as the origin processing center and/or the shipment coordination service. In some embodiments, the processing center is associated with a different entity.

At block 306, a carrier ships the package from the destination processing center to the destination. This segment of the shipment can be referred to as the destination shipment. The carrier ships the package based on instructions from the label on the package and/or information from the shipment coordination service. The carrier handling the destination shipment may be referred to as the destination carrier. In some embodiments, the origin carrier and the destination carrier are the same entity. In such an embodiment, the origin shipment with the entity and the destination shipment with the entity can be arranged as two separate shipment transactions with the shipment coordination service. Further details relating to the process 300 are explained below.

In one example scenario, a customer in the U.S. wants to send a package to a relative in Korea. The example scenario is provided for illustrative purposes and should not be considered to be limiting. The customer begins a transaction for the shipment of the package in the user interface provided by a shipment coordination service. The customer enters information for the shipment, such as his address, the relative's address, weight of the package, size of the package, etc. The customer schedules to have the package picked up at his house (i.e., origin address). The shipment coordination service can determine select a processing center for the package based on the origin address. Based on origin address and other relevant information, the system can select an origin carrier that will deliver the package from origin address to the selected processing center (e.g., origin processing center). Based on the destination address and other relevant information, the system also determines a destination carrier that will deliver the package to the destination address.

### Label Generation

The shipment coordination service generates a label that can be printed and attached on the package. The label can include shipping information that can be used by the origin carrier to process and ship the package to the selected processing center. For example, the origin carrier shipping information can include the origin address as the sender's address and the address of the origin processing center as the recipient address. The label can also include shipping information that can be used by the destination carrier to process the package. For example, the destination carrier shipping information can include at least the destination address as the recipient address. The label can also include shipping information that can be used by one or more processing centers to process the package (e.g., a unique identification or tracking code). The shipment coordination service can communicate with the origin carrier to coordinate the shipment to the package from the origin address to the origin processing center. The shipment coordination service can communicate with the destination carrier to coordinate the shipment of the package from the destination processing center to the destination.

The customer prints and attaches the label on the package and provides the package to the origin carrier. The origin carrier delivers the package to the origin processing center. The processing center can process the package based on the information on the label. For example, the processing center may recognize the package by a unique identification code or tracking code. The processing center can group the package with packages delivered from other customers by the same or different origin carriers. The packages can be grouped by destination, in this case, Korea. Packages with Korea as destination are sent to Korea through one or more intermediate carriers, such as a commercial airline.

The packages can be shipped to another processing center in Korea. The processing center receives the packages to be delivered within Korea. The processing center can sort the received packages according to destination carrier if there is more than one destination carrier. The processing center can transfer the packages to the appropriate destination carrier. The destination carrier can deliver the packages to their respective destinations. In this example, the destination carrier delivers the customer's package to the destination address.

### Shipment Coordination Service

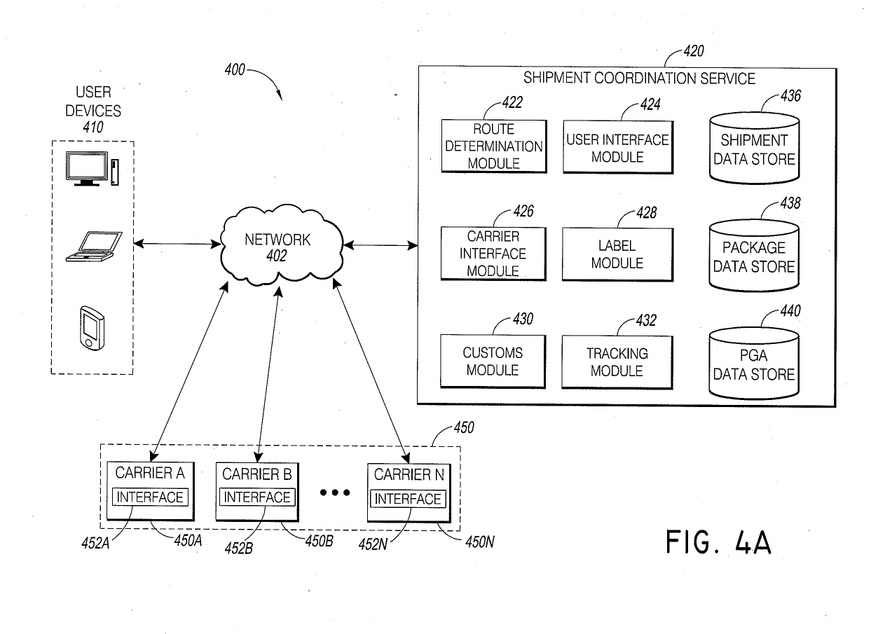

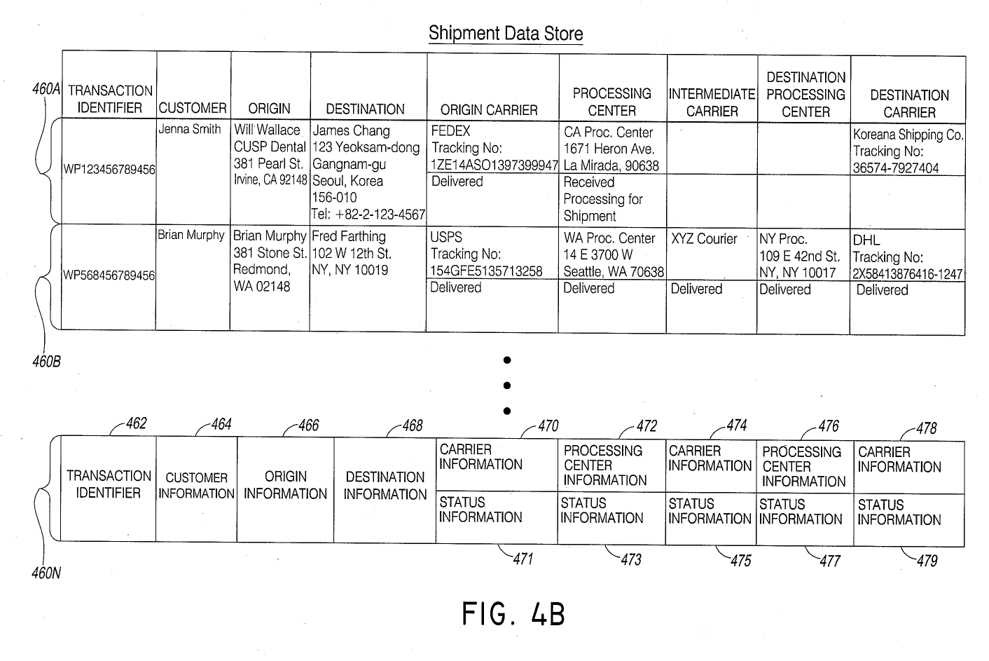

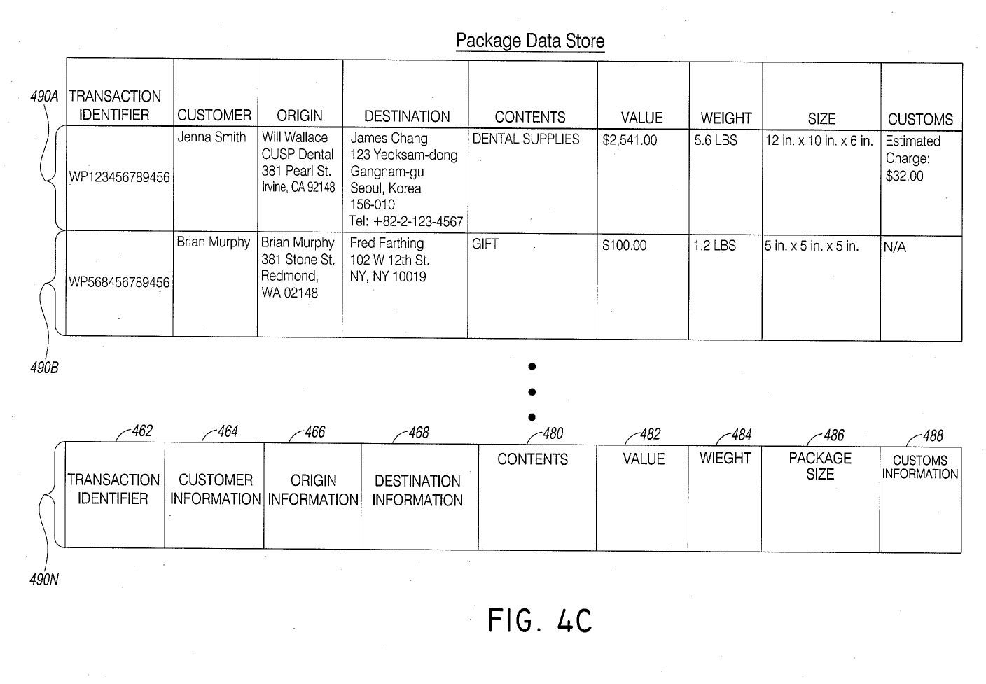

FIG. 4A illustrates a block diagram depicting an illustrative embodiment of a computing environment 400 for implementing a shipment coordination service 420. The operating environment 400 includes user devices 410, a communication network 402, a shipment coordination service 420 and carriers 450. The shipment coordination service 420 includes a plurality of modules and data stores. The user devices 410 can communicate with the shipment coordination service 420 via the network 402.

The shipment coordination service 420 can communicate with each carrier interface 452A-N via the network 402. Each carrier interface 452A-N is specific to the carrier 450A-N. There can be any number of carriers that are in communication with the shipment coordination service 420. The carriers can be located anywhere and be any type of carrier (e.g., USPS, UPS, FedEx, DHL, etc.). The carrier interface 452 can be accessed through the network 402 and provides an interface for the shipment coordination service 420 to interact with the carriers. Each carrier interface 452 can have its own application programming interface (API) that allows function calls to be made to the carrier interface 452 by the shipment coordination service 420.

Those skilled in the art will appreciate that the communication network 402 may be any wired network, wireless network or combination thereof. In addition, the communication network 402 may be a personal area network, local area network, wide area network, cable network, satellite network, cellular telephone network or combination thereof. Protocols and components for communicating via the Internet or any of the other aforementioned types of communication networks are well known to those skilled in the art of computer communications and thus, need not be described in more detail herein.

The user computing devices 410 can correspond to a wide variety of devices or components that are capable of initiating, receiving or facilitating communications over the communication network 402 including, but not limited to, personal computing devices, electronic book readers (e.g., e-book readers), hand held computing devices, integrated components for inclusion in computing devices, home electronics, appliances, vehicles, machinery, landline telephones, network-based telephones (e.g., voice over IP (“VoIP”), cordless telephones, cellular telephones, smart phones, modems, personal digital assistants, laptop computers, gaming devices, media devices, and the like. In an illustrative embodiment, the user computing devices 410 include a wide variety of software and hardware components for establishing communications over one or more communication networks, including wireless communication network, a wired communication network, or an IP-based telecommunication network.

The shipment coordination service 420 can communicate with user devices 410 and carrier interfaces 450 via the network. The shipment coordination service 420 can include one or more functional modules that are configured to execute various functions, including a route determination module 422, a user interface module 424, a carrier interface module 426 and a label module 428. The shipment coordination service 420 can have one or more data stores for maintaining and storing information and data entries related to the shipment coordination service 420. In some embodiments, the data store 430 can be incorporated into the shipment coordination service 420. In some embodiments, the data store 430 can be located remotely and accessible over a network.

The shipment coordination service 420 can be implemented by one or more physical computing devices, such as servers. These servers can be physically co-located or can be geographically separate, for example, in different data centers.

### Transaction Identification Code

The shipment coordination service 420 can conduct transactions with users in order to coordinate shipments using a plurality of carriers. The shipment coordination service 420 can generate a unique transaction identification code (UTIC) for the transaction. This code may also be referred to as the shipment tracking code or shipment identification code. The unique transaction identification code can be used to identify the shipment while it is in process. For example, a user can access information about the entire shipment using the unique transaction identification code. The user can enter the unique transaction identification code in a shipment coordination service user interface and view the status of the delivery of the package from the origin to the destination, including any status information relating to the various shipments (e.g., origin, intermediate and/or destination shipments).

### Route Determination Module

The route determination module 422 can determine the route for the transaction based on the input received by the user. The user may provide package characteristics and delivery characteristics. Package characteristics can include, but not limited to, package weight, package size, package contents and other information relating to the physical characteristics of the package. Delivery characteristics can include, but not limited to, the origin, destination, delivery timeframe, package handling instructions, and other logistical characteristics related to the delivery of the package from an origin to a destination. The route determination module 422 can utilize the delivery and package characteristics to determine a route from the origin to the destination. The route can have a plurality of segments. The route determination module 422 can use one or more algorithms to determine the specific route and identify a carrier for each segment of the route. The route determination module 422 can optimize the selection of the route based various criteria such as cost, delivery timeframe, carrier type, or other criterion. The route selection criteria can be influenced by user input, such as time or cost. The specific route can be based, at least in part, on carrier information stored in data store 436 or 438 and information received from the carrier interface module 426.

### User Interface Module

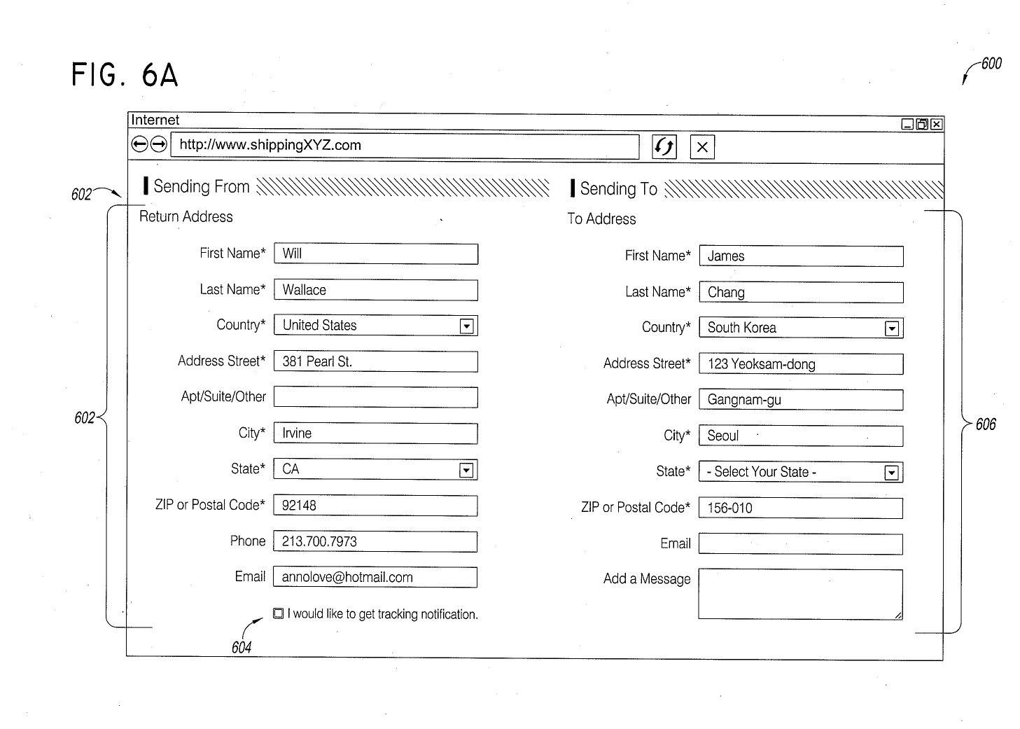

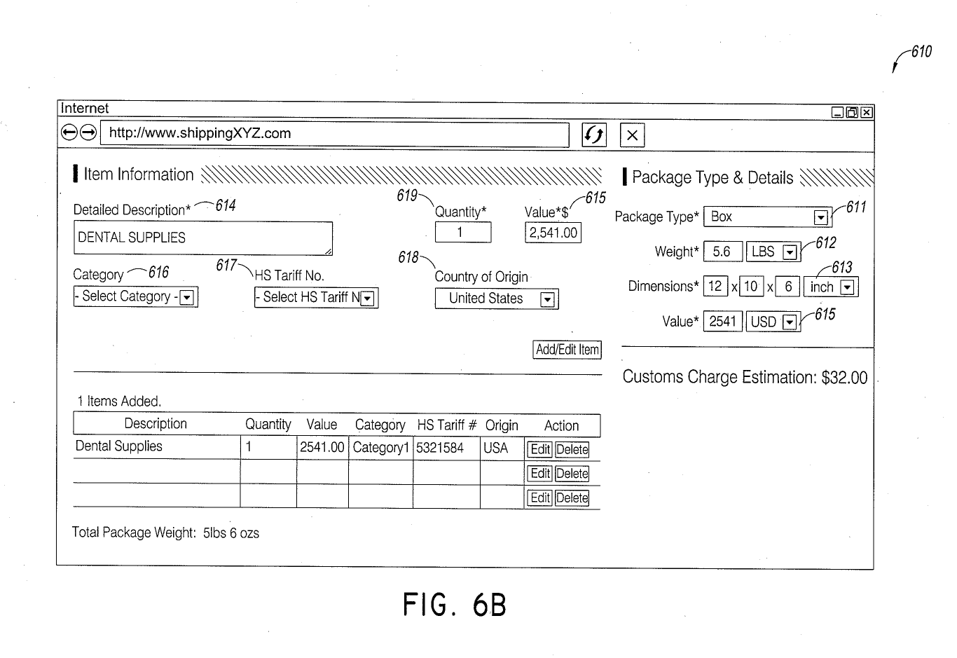

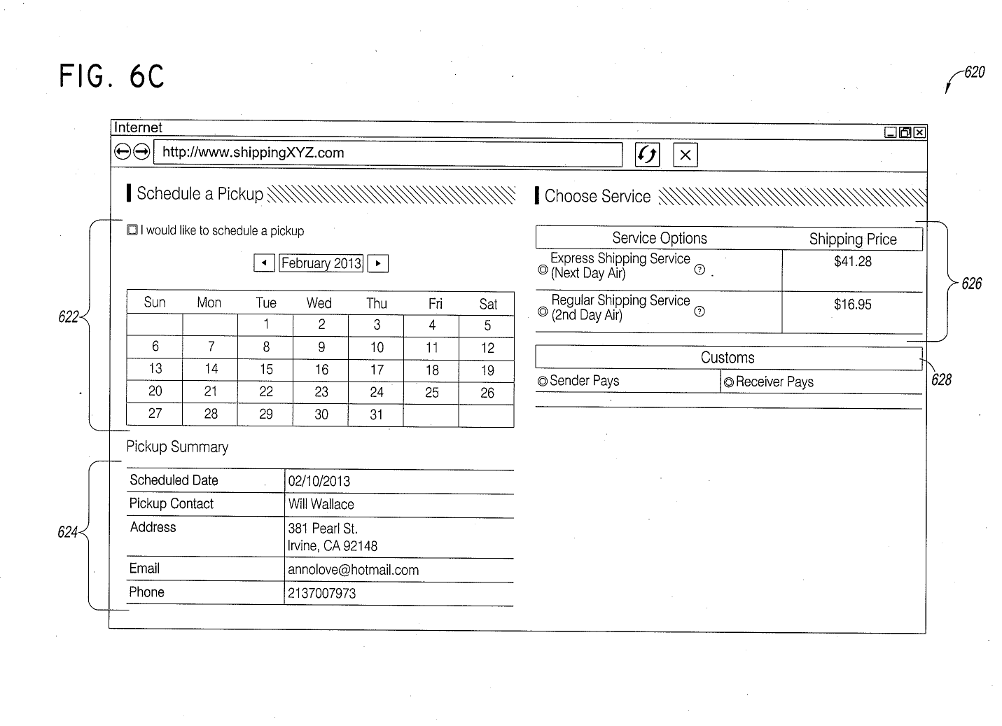

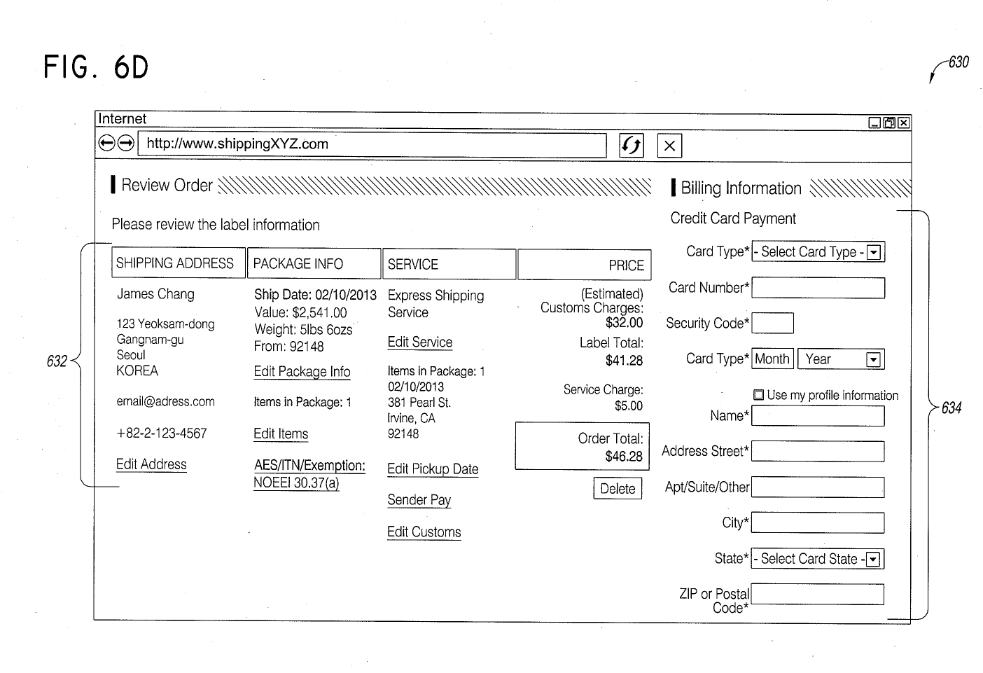

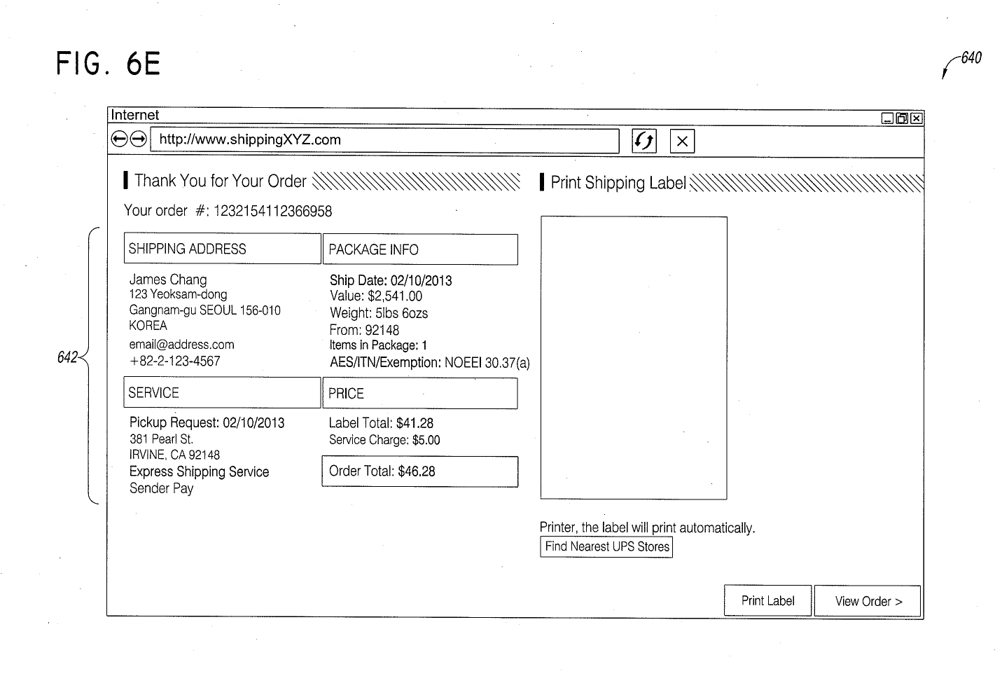

The user interface module 424 can generate a user interface for the user devices 410 to access the shipment coordination service. The user interface provides an interface through which a user can conduct a transaction for a shipment of a package. The user interface can be a network-based interface that includes one or more web pages that a user can navigate to conduct the transaction. In some embodiments, the user interface module 424 can manage user accounts that are associated with each user. The user accounts can store information relating to each transaction performed by a user. The user interface can receive shipment information from the customer relating to the transaction. The shipment information the customer enters can include delivery characteristics, including, but not limited to: origin address, destination address, package information, etc. Package information can include, but is not limited to package type, weight, size (e.g., dimension), description, package value (e.g., for international packages, for example, customs purposes), etc. The user interface module can receive other information used to place a shipment order, such as billing information. The user interface module can store the transaction information in the data store 430. The user account can be accessed by a user to track the progress of scheduled shipments. Exemplary embodiments of user interfaces generated by the user interface are illustrated in FIG. 6.

### Carrier Interface Module

The carrier interface module 426 can coordinate communications between the shipment coordination service 420 and the carrier interfaces 452. The carrier interface module 426 can communicate with the carrier interfaces 452 of any number of carriers 450 to arrange and coordinate the shipment of packages. The carrier interface module 426 can communicate with a plurality of carrier interfaces 450 for each transaction. For example, in a single transaction the carrier interface module 426 can interface with an origin carrier, an intermediate carrier, and a destination carrier. For each segment, a different carrier, which utilizes a different carrier interface, can be selected. In some embodiments, the carrier interface module can implement a carrier interface on the shipment coordination service 420 that is used to communicate with each carrier 450.

### Label Module

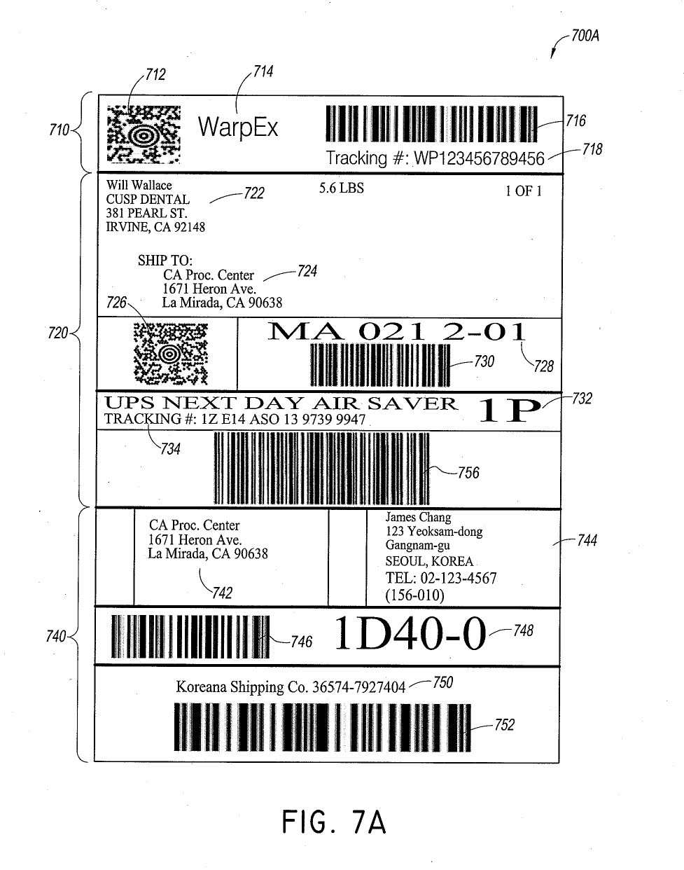

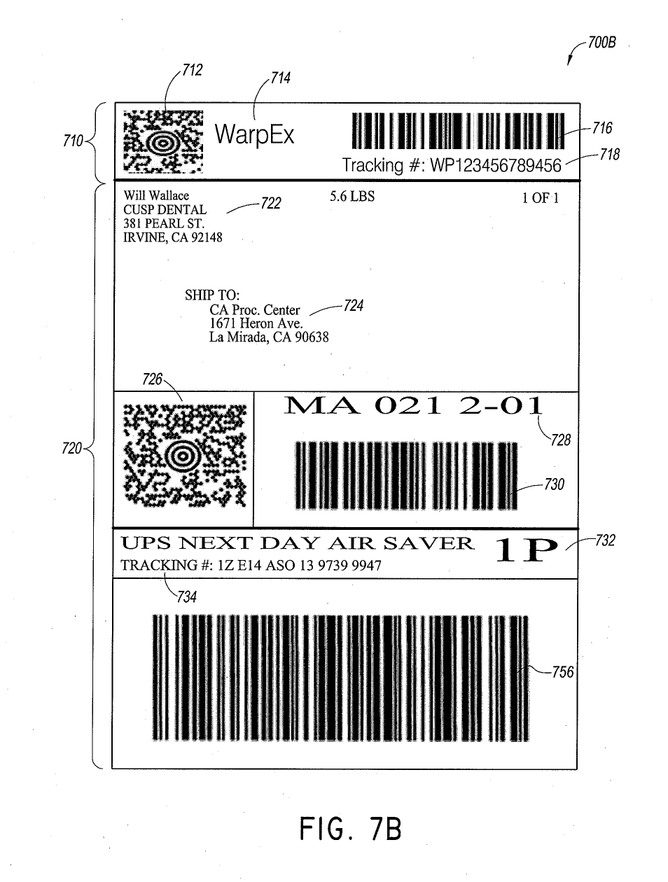

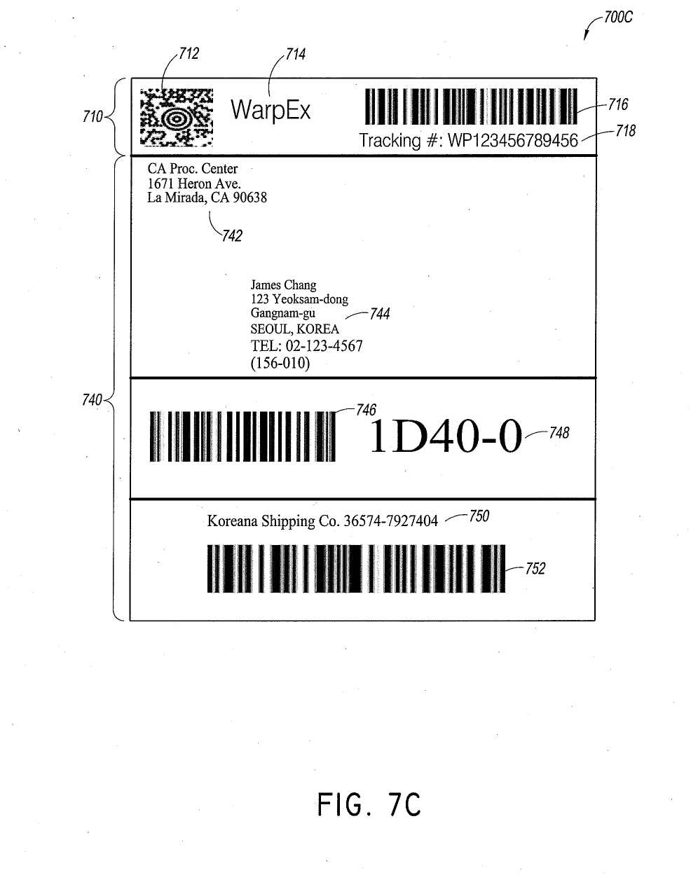

The label module 428 can generate labels associated with the shipment transaction. The label module 428 can generate labels that include information that is used to process and deliver the package. In some embodiments, the label includes shipping information for a portion of the shipment between the origin shipment and the destination shipment (e.g., between the origin and the origin area processing center The label can include processing center shipment information that is recognized and utilized by a processing center to process and sort the package. The label module 428 can generate various different types of labels depending upon the specific details of the transaction. Exemplary embodiments of labels that can be generated are illustrated in FIGS. 7A-7C.

### Customs Module

The customs module 430 can include customs and tariff information that is used by the SCS 420 for international shipments. The customs module can have a defined rule set stored in a customs data store. The customs module can use the rule set and the user information to determine whether the shipment complies with customs requirements and regulations for the specific destination country. The rules set can provide information regarding taxable goods, costs, and other customs information associated with specific countries. The customs module 430 can determine taxes that would be applied to a shipment and add the amount to the total amount required for shipping the package. In some embodiments, the customs module 430 can determine based on the contents of the package, as identified by the user, whether the package can be shipped to the specific country. For example, countries can have specific regulations that impose strict shipping requirements on specific types of goods. In some embodiments, the customs module 430 can identify to the user a regulation that would be violated by a proposed shipment.

### Tracking Module

The tracking module 432 can be used to track the shipment status of a package. The tracking module 432 can use the unique transaction identification code of a shipment to determine the current status of the shipment. Based on the unique transaction identification code, the tracking module can identify the carrier specific tracking code associated with each segment of the shipment. For example, the carrier specific tracking code can be included within the shipment data store (described below). The tracking module can use the carrier tracking code to determine the status of the package and update the status in the shipment data store. This allows a user to request a shipment status update from the SCS 420 without requesting a status update from each carrier individually.

The shipment coordination service 420 can include a plurality of data stores. In this embodiment, the SCS includes a shipment data store 436, a package data store 438 and a geographical area data store 440. In some embodiments, the shipment coordination service 420 can include additional data stores, such as, a carrier data store, a user data store, a customs data store, and other data stores for storing information associated with carrying out functions of the shipment coordination service 420. A user data store can include information associated with customer transactions. The user data store can include a user profile for each customer that includes information associated with each transaction associated with a user. A data entry relating to each transaction can be stored in one or more data stores.

### Shipment Data Store

The shipment data store 436 can include information associated with each shipment transaction. The information included in each shipment database entry can be associated with and include the unique transaction identification code associated with the shipment. The shipment database entry can include various types of information relating to the transaction, such as origin, destination, origin carrier tracking code, destination carrier tracking code, information relating to the origin carrier, intermediate carrier(s) and the destination carrier. An illustrative embodiment of information stored in the shipment data store is illustrated in FIG. 4B.

### Package Data Store

The package data store 438 can include information associated with the package being shipped. The package data store can include information such as package contents, value, weight, size, customs information, and other package related information. The information included in each package database entry can be associated with and include the unique transaction identification code associated with the shipment. An illustrative embodiment of data stored in the package data store 436 is illustrated in FIG. 4C.

### Geographical Area Data Store

The geographical area data store 440 can include information about predetermined geographical areas. A predetermined geographical area can be a city, a county, a state, a country or other arbitrarily defined region. Any area can be divided into one or more predetermined geographical areas. For example, a country may be divided into two or more predetermined geographical areas. The data store can include a list of predetermined geographical areas and related information. An illustrative embodiment of information stored in the geographical area data store 438 is illustrated in FIG. 2B.

### Carrier Data Store

A carrier data store can include information associated with carriers. A carrier data store can include any entity that is capable of the shipment and delivery of packages. The carrier data store can associate each carrier with one or more of the predetermined geographical areas. For example, a group of carriers may be associated with one predetermined geographical area, and another group of carriers may be associated with another predetermined geographical area. Some examples of carriers include UPS, FedEx, DHL, etc. The carrier data store can include characteristics associated with each carrier that are used by the shipment coordination service 420 to coordinate the shipment of packages. Such characteristics can include, but not limited to, pricing, shipment timeframes, areas of operation and other operational characteristics relevant to each carrier. The carrier data store can include information used by the carrier interface module 428 to communicate with the carriers 450.

### Customs Data Store

A customs data store can include international shipping information such as laws and regulations that govern the shipment of packages within countries. The customs data store can include tax information, regulations, rules, information associated with the shipment of specific goods and products and other country specific information that can affect how goods are shipped between countries. For example, the customs data store could include lists of items that are prohibited to be shipped within a country, and or regulations that govern the quantity of a specific product that may be shipped within a single package. The customs database can also include information governing shipments between countries, such as countries that are members of the Universal Postal Union (“UPU”), and other information that can be used to help determine how to route international packages.

### Shipment Data Store Embodiment

FIG. 4B provides an illustrative example of an embodiment of data stored in a shipment data store 436. The shipment data store includes a plurality of data sets 460A-N. The data sets 460A and 460B illustrate instances of data sets associated with two separate shipments. The data set 460N illustrates the type of data that is stored within each data set. In this embodiment the data stored in each data set includes a transaction identifier 462, customer information 464, origin information 466, destination information 468, origin carrier information 470 and associated status information 471, origin processing center information 472 and associated status information 473, intermediate carrier information 474 and associated status information 475, destination processing center information 476 and associated status information 477, and destination carrier information 478 and associated status information 479. Other embodiments of the data store can include more or fewer data entries than those illustrated in this embodiment.

The transaction identifier 462 can be the unique transaction identification code associated with the shipment. The transaction identifier can be used to keep track of the information associated with the shipment in multiple data stores. For example, the package data store 436 can use the same transaction identifier to store package data associated with the shipment.

The customer information 464 can include information that can be specific to the customer, such as name, address, and other account information. The customer information can be different that the information associated with the origin information 466 or the destination information 468. The origin and destination information can store information such as name, address, telephone number and other information. The carrier information 470, 474, 478 can be specific to the carrier. The information can include the carrier name, shipment tracking code, address, and/or other information associated with the specific shipment of the package by the identified carrier. The processing center information can include information such as the identification of the processing center, address, and other information. For each carrier and processing center, there can be associated status information, which can provide the status of the shipment by the carrier. Various examples of status information is shown in data sets 460A and 460B.

### Package Data Store Embodiment

FIG. 4C provides an illustrative example of an embodiment of data stored in a package data store 438. The shipment data store includes a plurality of data sets 490A-N. The data sets 490A and 490B illustrate instances of data associated with two separate shipments, which are the same two shipments associated with data sets 460A and 460B in FIG. 4B. The data set 490N illustrates the type of data that is stored within each entry within a data set 490. In this embodiment, the data stored in each data set includes a transaction identifier 462, customer information 464, origin information 466, destination information 468, package contents 480, package value 482, package weight 484, package size 486 and customs information 488. In this embodiment, the package data store includes the same data entries for the transaction identifier 462, customer information 464, origin information 466 and the destination information 468 as the shipment data store 434 to associate the same shipment within both data stores. In some embodiments, the package data stores may use only the transaction identifier to associate information between data stores.

### Shipment Coordination Service Interactions

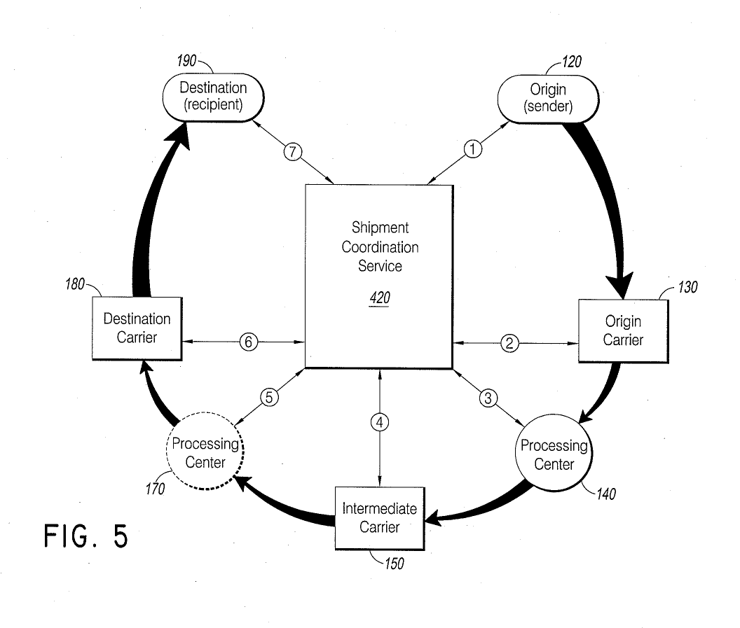

FIG. 5 illustrates interactions between the shipment coordination service 420, user devices 410, carriers 450 and processing centers during an exemplary transaction for shipping packages using a plurality of carriers according to one embodiment of the invention. The shipment coordination service 420 is utilized to coordinate and process the shipment of a package from an origin to a destination using one or more carriers. The carriers may be associated with a different entity than the shipment coordination service. As explained above, a different carrier can be scheduled to deliver the shipment of the package at each segment. Users can interact with the shipment coordination service 420 through a user interface, which can be implemented by the user interface module 424 as described above. The shipment coordination service 420 can interact with each carrier through a carrier interface, which can be implemented by a carrier interface module 426 as described above. For simplicity, the reference numbers used to identify the elements in FIG. 5 are the same as the reference numbers used to identify the same elements in FIGS. 1A and 1B.

In one embodiment, at (1) a user, through user device 410, places an order through the user interface. The customer can provide the origin 120 and the shipment coordination service 420 can select the predetermined geographic area that includes or encompasses the origin 120. One or more carriers 450 can be associated with the origin area 110. The shipment coordination service 420 can select an origin carrier 130 from the list of carriers associated with the origin area. The user can provide a destination 190 and the shipment coordination service 420 can select predetermined geographic area destination area (e.g., a predetermined geographic area) 160 that includes or encompasses the destination 190. One or more carriers can be associated with the destination area 160. The shipment coordination service 420 can identify one or more processing centers based on the origin area and the destination area. The shipment coordination service can store information associating one or more carriers that can ship the package from the origin area processing center 140 to the destination area processing center 170. The shipment coordination service 420 can identify an intermediate carrier 150 that can ship the package from the processing center 140 to processing center 170. The shipment coordination service 420 can store information associating one or more carriers that can transport the shipment between destination processing center 170 and the destination 190. The shipment coordination service 420 can select a destination carrier 180 from the list of carriers associated with the destination area.

### Origin Carrier Interactions

After the shipment transaction is complete, the origin carrier 130 transfers the package from the origin 120 to the processing center 140. The origin carrier 130 can be associated with the same entity as the shipment coordination service 420. At (2), the shipment coordination service 420 can communicate with an origin carrier interface 452 through the carrier interface module 426. The shipment coordination service 420 may communicate with the origin carrier 450A to obtain a unique identification code assigned by the origin carrier 130. The unique identification code assigned by the origin carrier 130 can be referred to as an origin carrier tracking code. The origin carrier tracking code can be used by the origin carrier 130 to identify the package during the origin shipment. The origin carrier tracking code can be assigned during the transaction. For example, the shipment coordination service 420 may obtain a unique identification code by requesting one from the origin carrier 130 system during the transaction. The origin carrier tracking code can also be pre-assigned. For example, the origin carrier 130 may assign a range of unique identification codes to the shipment coordination service 420 that it can assign as appropriate for a delivery. The shipment coordination service 420 may also communicate with the origin carrier 450A to provide details of the origin shipment, such as status updates and other shipment information. In some embodiments, the package may include the address of the processing center 140 and the address of the destination 190.

### Processing Center Interactions

The processing center 140 processes the package along with other packages received at the processing center 140 from the same origin carrier 130 or other carriers. The packages can be grouped by destination. At (3), the processing center 140 can communicate with the shipment coordination service 420 to receive package information, provide package status updates, and other shipment information. In some embodiments, the processing center 140 can communicate with the shipment coordination service 420 to receive additional information for processing and shipment of the package. For example, the processing center 140 may add an additional label to the package that includes the address of the final destination 190. The processing center can perform a quality check on the package, such as verifying the integrity of the packaging and labels, checking the weight and size, and/or perform other quality related checks. The processing center can replace a damaged label, add additional labels and/or perform other actions associated with the package.

### Electronic Labels

In some embodiments, the processing center 140 can add an electronic label to the package. The electronic label can be used for processing, tracking and shipment of the package. The electronic label can use radio frequency identification (RFID) technology, or other technology for wirelessly communicating information from the label to a computing device. The electronic label can supplement information included on a printed label. The electronic label can include information associated with the package, including information stored in data stores associated with the shipment, such as the shipment data store, the package data store and/or portions of the data stored thereon. The electronic label can store information that would not be desirable to be printed on a package label, such as package contents, value and other information.

In some embodiments, the electronic label is associated with the shipment coordination service 420 and used by each of the plurality of carriers to receive carrier specific information. The customer can purchase the label and load the information onto the label prior to shipping the package. The electronic label can communicate carrier specific information associated with a segment of the overall shipment. The electronic label can communicate information specific to a carrier identification code. In this manner, only a portion of the information stored on the label could be communicated to each carrier.

The processing center 140 provides the grouped packages to an intermediate carrier 150 to deliver to another processing center 170 or an intermediate location prior to shipment by the destination carrier 180 to the recipient at the final destination 190.

The packages are provided to one or more intermediate carriers 150. The one or more intermediate carriers 150 deliver the packages from the processing center 140 to a processing center 170 or another intermediate location. At (4), the intermediate carrier can communicate with the shipment coordination service 420 to receive package information, provide package status updates, and other shipment information. An intermediate carrier may refer to a carrier that is in charge of a portion of the shipment of the package from a processing center 140 of the company or another intermediate location. There can be a plurality of intermediate carriers that are responsible for inter-area shipments between the processing center 140 and the processing center 170.

### Destination Carrier Interactions

The destination carrier 180 can deliver the package from the processing center 170 or an intermediate location to the destination 190. An intermediate location may be a predetermined location within the destination area 160. The portion of the shipment from a processing center 170 or an intermediate location to the destination 190 handled by the destination carrier 180 can be referred to as the destination shipment. The processing center 170 can process the package similar to the processing center 140 prior to delivering the package to the destination carrier 180. At (5), the processing center 170 can communicate with the shipment coordination service 420 to receive package information, provide package status updates, and other shipment information.

The shipment coordination service 420 can communicate with the destination carrier 180 to provide additional information or instructions regarding the shipment. At (6), the shipment coordination service 420 may communicate with the destination carrier 180 to obtain a unique identification code assigned by the destination carrier 180. The unique identification code assigned by the destination carrier 180 can be referred to as destination carrier tracking code. The destination carrier tracking code can be associated with the destination shipment and can be used by the destination carrier 180 to identify the package during the destination shipment. The destination carrier tracking code can be assigned during the transaction, pre-assigned, or after the transaction. The shipment coordination service 420 may also communicate with the destination carrier 180 system to provide details associated with the destination shipment, such as status updates and other shipment information.

The destination carrier 180 delivers the package to the destination 190. At (7), the recipient at the destination, or any other user that has shipment identifier information, can communicate with the shipment coordination service to receive status updates regarding the tracking of the shipment from the origin to the destination. The shipment coordination service 420 can coordinate the tracking information for the entire shipment from the origin to the destination, such that the user does not have to interface with each carrier individually to receive the updated tracking information. User Interface

FIGS. 6A-6E depict various user interfaces for interacting with the shipment coordination service. Each of the user interfaces shown includes one or more user interface controls that can be selected by a user, for example, using a browser or other application software. The user interface controls shown are merely illustrative examples and can be varied in other embodiments. For instance, buttons, dropdown boxes, select boxes, text boxes, check boxes, slider controls and other user interface controls shown may be substituted with other types of user interface controls that provide the same or similar functionality. Further, user interface controls may be combined or divided into other sets of user interface controls such that similar functionality or the same functionality may be provided with very different looking user interfaces. Moreover, each of the user interface controls may be selected by a user using one or more input options, such as a mouse, touch screen input or keyboard input, among other user interface input options.

### User Interface

Turning to FIG. 6A, an example user interface 600 is shown implemented on a browser application on a user device. In one embodiment, the user interface 600 is a web interface that includes one or more web pages. The example user interface 600 includes functionality for conducting a transaction for shipment of a package. In particular, the user interface includes inputs for a user to provide information for shipping a package from an origin to a destination. The origin inputs 602 can include information associated with the sender and the origin address. the origin inputs can include, but not limited to, name, country, address, city, state, postal code, phone, e-mail address and other inputs. The user interface 600 can also include inputs 604 associated with tracking notifications for the shipment of the package from the origin to the destination. The destination inputs 606 can include, but not limited to, name, country, address, city, state, postal code, phone, e-mail address, and other inputs.

The origin address may refer to a location where the shipment of the package begins. For example, the origin can be a sender's home, work or drop off location of the origin carrier. The destination address may refer to a location where the shipment of the package ends. For example, the destination can be the recipient's home or work.

### User Interface—Package Information

Turning to FIG. 6B, an example user interface 610 is shown that includes inputs for providing package information. Package information can include, but is not limited to: package type 611, weight 612, size (e.g., dimensions) 613, description 614, package value 615, package category 616, tariff information 617, country of origin 618, quantity 619, and others characteristics associated with the package. The package value can be used to determine insurance costs, custom rates for international shipping and other purposes as required. For example, in one instance a user can indicate the package type is a box having a specific weight and dimension information.

The user interface 610 can provide functionality for a user to add a plurality of packages to the current shipment. For example, in the illustrated instance the user has included three packages within the shipment. The user interface can also display information that is dependent upon the origin and destination information that is provided by the user in user interface 600. For example, if the shipment is domestic shipment, the user interface may omit the customs or tariff information. If the shipment is an international shipment, the user interface 610 can display information associated with international packages, such as customs or tariff information.

### User Interface—Delivery Service Information

Turning to FIG. 6C, an example user interface 620 is shown that provides inputs 622 for the user to specify a date for pickup. The user interface 620 can also specify information 624 associated with the pickup. The user interface 620 can include inputs 626 for selecting a type of service. The type of service can refer to service options provided by the company or the various carriers. The types of services that are offered can be dependent upon the origin and destination addresses, the package information, and other information provided by the user or maintained by the shipment coordination service. The type of service can designate the delivery method, such as ground, air, or sea transport, priority level, speed of delivery and other service related attributes. For instance, the customer can choose to send the package by express service or regular service. In some instances, dependent upon the carrier, the customer can schedule a pickup by the origin carrier. The user interface 620 can also include inputs 628 associated with customs, for example, which party pays for shipping customs.

### User Interface—Payment Information

Turning now to FIG. 6D, an example of a payment screen user interface 630 can is shown. The user interface can include a summary of the transaction 632 and inputs 634 for the user to arrange for payment of the shipment. The customer may pay using various method of payment provided by the shipment coordination service 420, such as credit card, debit card, checking account, etc. The customer can enter billing information in the payment screen 630.

### User Interface—Order Review

Turning now to FIG. 6E, an example of an order review user interface 640 is shown that can be displayed after the user has scheduled the shipment and provided the appropriate information. The review order screen can display a summary 642. The summary can include, but not limited to, the origin address, destination address, package information, service type, cost for the shipment, etc. In some embodiments, the user interface 640 may also show a preview of the label that can be printed and attached onto the package for shipment. The label is described in more detail below. In certain embodiments, the user interface 640 can provide a control for finding the nearest location of the origin carrier selected by the shipment coordination service.

### Shipping Labels

FIGS. 7A-7C illustrate example embodiments of shipping labels 700A-C. The shipping labels 700A-C can include information that is used to process and deliver the package. The shipping labels 700A-C can include information for one or more segments of the shipment between the origin and the destination. The shipping labels 700A-C can include various types of information depending on the origin, destination, intermediate destinations, route and carriers. In some embodiments the labels 700A-C can include shipment information 710 associated with the shipment coordination service shipment information 720, associated with the origin carrier and shipment information 740 associated with the destination carrier. For example, FIG. 7A illustrates an example of a shipping label 700A that includes shipment information (or overall shipping information) 710, origin shipment information 720 and destination shipment information 740. FIG. 7B illustrates an example of a shipping label 700B that includes shipment coordination service shipment information 710 and origin shipment information 720. FIG. 7C illustrates an example of a shipping label 700C that includes shipment coordination service shipment information 710 and destination shipment information 740. In embodiments, the labels may include overall shipping information 710, origin shipment information 720 and/or destination shipment information 740 in different order and configurations.

### Label—Shipment Coordination Service Information

In the illustrated embodiments, the shipment coordination service shipment information 710 can include a unique identification code 712, a shipment coordination service identifier 714, a shipment coordination service bar code 716, and an alphanumeric tracking number 718. In other embodiments the shipment coordination service information can include additional or fewer elements in accordance with the information that is needed to ship and process the package from the origin to the destination. In some embodiments, the identification code 712 is a unique tracking identification code (UTIC), such as a barcode, a QR code, a two-dimensional barcode, a tracking number, a tracking code, or any code that is capable of identifying the package and/or associating the package with a specific shipment transaction of the shipment coordination service 420. The unique tracking identification code can be of any form currently existing or to be developed in the future. In some embodiments, the unique identification code can be assigned by the shipment coordination service 420, a company or business associated with the shipment coordination service 420, a carrier other than the shipment coordination service 420, or a third-party provider. The unique transaction identification code can be used to identify the shipment with the shipment coordination service 420. The carriers can use the unique transaction identification code to update the shipment coordination service 420 on the status of the delivery of the package. For example, the shipment coordination service could be updated at each segment of the overall delivery.

In some embodiments, the identification code 712 can encode information such as a primary message and a secondary message. In some embodiments, the primary message can include the postal code, country code and the class of service number, and the secondary message can include address data. Other types of information can be encoded in the identification code 712 as well.

In some embodiments, the shipment coordination service shipment information 710 can include information that is recognized by a processing center and/or intermediate carriers. The processing center can use the information to process the package for shipment. For example, the information can include instructions to attach an additional label on the package, such as the label 700C, that is placed by the processing center after the origin shipment. In some embodiments, the information can be contained within the shipment coordination service shipment information 410 or in another portion of the label.

### Label—Origin Shipment Information

The origin shipment information 720 can include information that is used by the origin carrier to deliver the package from the origin to the origin area processing center. The origin shipment information 710 can include the origin address 722, the address of the intermediate destination 724, and carrier specific label information, such as an identification code 726, a routing code (a zip code equivalent for the origin carrier) 728, a routing bar code 730 that corresponds to the routing code 728, level of service 732, a tracking number 734, a tracking bar code 736 that corresponds to the tracking number 734, and other information such as package handling instructions.

### Label—Destination Shipment Information

The destination shipment information 740 can include information that is used by the intermediated carrier and/or the destination carrier to deliver the package to the destination or an intermediate location prior to delivery to the destination. The destination shipment information 740 the address of the intermediate destination 742, the destination address 744, and carrier specific label information, such as an identification code (not shown), a routing code (a zip code equivalent for the destination carrier) 748, a routing bar code 746 that corresponds to the routing code 748, a tracking number 750, a tracking bar code 752 that corresponds to the tracking number 750, and other information such as package handling instructions. In one instance, the intermediate destination 742 can be the same as the destination 724.

In some embodiments, the label includes origin shipment information 720, but does not include destination shipment information 740, such as label 700B illustrated in FIG. 7B. The label 700B can include information in the shipment coordination service shipment information 710 that is used by an intermediate carrier to process the package. For example, a processing center can recognize and process the package based on the origin carrier unique tracking identification code. The information associated with the unique tracking identification code can provide the information needed by the processing center to ship the package to the correct destination. For example, the processing center may print out label 700C and place it on the package based on the information associated with the unique identification tracking code.

The identification codes for each carrier, such as the origin carrier and the destination carrier, may be displayed on the label in the form of a computer readable code on the same label. In some embodiments, the processing center shipment information and/or the intermediate shipment information may also be displayed on the label in the form of a computer readable code. The one or more codes can be scanned by the respective shipping entity to identify the package. For example, the origin carrier can scan codes associated with the origin carrier, and the destination carrier can scan the codes associated with the destination carrier. In some embodiments, the codes for each carrier are sequentially activated and codes associated with subsequent segments of the shipment may not be activated until the previous phases have already been completed. The identification codes may be associated with or be in the form of a serial number. For example, the identification code may be a series of alphanumeric characters.

The label can be in the form of an integrated sheet that includes both the origin shipment information and the destination shipment information, as illustrated by label 700A in FIG. 7A. The integrated sheet can also include processing center shipping information and intermediate shipment information, depending on the embodiment. In some embodiments, the label can also have a separate sheet for each type of information listed above (e.g., origin shipment information, destination shipment information, processing center shipping information, intermediate shipment information, etc.). In some embodiments, the label can also have a separate sheet with any combination of types of information listed above (e.g., origin shipment information, destination shipment information, processing center shipping information, intermediate shipment information, etc.) or other shipping information associated with the specific carrier and/or processing center.

### Shipment Coordination Process

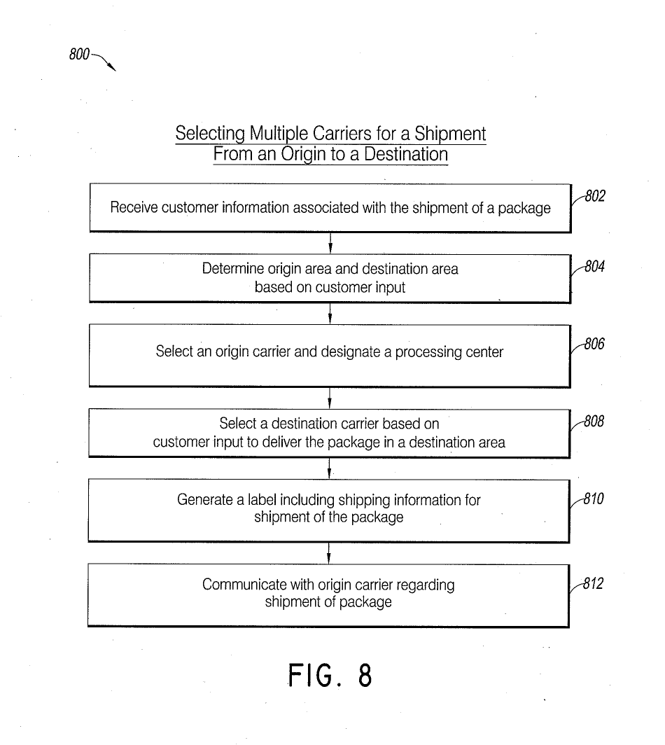

FIG. 8 illustrates a flowchart of a process 800 for coordinating shipment of a package by an shipment coordination service between an origin and a destination using one or more carriers. The process 800 is explained with respect to shipment coordination service 420 in FIG. 4 for illustrative purposes, but the process 800 can be implemented by any other system as appropriate. The process 800 is shown to include certain blocks in FIG. 8, but one or more blocks can be omitted and additional blocks can be added depending on the embodiment. The blocks of the process 800 can also be performed in an order different from the order shown in FIG. 8.

At block 802, the shipment coordination service 420 receives information for the shipment of a package from a user within a user interface provided by the shipment coordination service 420. The information received by the shipment coordination service 420 from a user includes at least an origin and a destination. The information received by the shipment coordination service 420 can also include, but is not limited to, number of packages, package information, type and level of service, time frame and other information associated with the shipment of the package from the origin to the destination. In some embodiments, the customer may designate the location of the origin carrier from which the customer wants to ship the package and/or an origin address. The shipment coordination service 420 can determine a route for the shipment from the origin to the destination including at least one intermediate destination (e.g., a processing center).

The shipment coordination service 420 can create a data entry relating to the transaction in the shipment data store 436, the package data store 438 and other data stores. The shipment coordination service 420 can generate a unique transaction identification code for the transaction of the shipment from the origin to the destination.

At block 804, the shipment coordination service 420 determines an origin area and destination area based on customer input. The shipment coordination service 420 can determine the origin area from one of a plurality of predetermined geographical areas that includes the origin provided by the customer input. The shipment coordination service can use the data stored in the geographic area data store to determine the specific origin area. The predetermined geographic area that includes the origin can be referred to as the origin area. In instances where the user designates the location for drop off to the origin carrier, the shipment coordination service 420 can select an origin area based on the designated origin carrier drop off location. The shipment coordination service 420 can determine the destination area from one of a plurality of predetermined geographical areas that includes the destination provided by the customer input. The shipment coordination service can use the data stored in the geographic area data store to determine the specific destination area.

At block 806, the shipment coordination service 420 selects an origin carrier, based at least in part, on information provided by the user. The shipment coordination service 420 can select an origin carrier from the list of carriers associated with the origin area. The origin carrier may be selected based on a number of factors, such as the origin address, the service selected by the customer (e.g., express or regular), size and weight of the package, rates offered by the origin carrier, and/or other factors. The shipment coordination service 420 may automatically select the origin carrier based on the customer input. The shipment coordination service 420 can select the origin carrier during the transaction or at any time before the transaction is complete. In some embodiments, the user is not notified of the identity of the origin carrier until the transaction is complete.

In some embodiments, the shipment coordination service 420 may communicate with the origin carrier interface to obtain an identification code assigned to the package by the origin carrier. The origin carrier identification code can be assigned during the transaction. In some embodiments, the origin carrier identification code can be pre-assigned by the shipment coordination service 420. For example, the shipment coordination service 420 assigns the origin carrier identification code based on a preselected range of identification codes provided to the shipment coordination service 420 by the carrier. The shipment coordination service 420 can communicate the selected origin carrier identification code to the origin carrier during the shipment transaction.

The shipment coordination service 420 can also designate a processing center within the origin area to which the origin carrier delivers the package. The origin area processing center can be associated with the same entity as the shipment coordination service 420. The origin area processing center is the destination for the origin shipment. The scheduled shipment between the origin and the processing center can be an intra-PGA shipment. In some instances, the processing center may be located close to an airport, a port, a rail station or other transportation center. The processing center can process packages delivered to the processing center from various carriers (e.g., sorting into groups for delivery to respective destinations). In some embodiments, the shipment coordination service 420 may select the origin predetermined geographic area based at least in part on the location of the processing center 140. In some embodiments, the processing center is not associated with the origin carrier.

At block 808, the computing shipment coordination service 420 selects a destination carrier 107 based on the customer input to deliver the package in a destination area. The shipment coordination service 420 can determine a predetermined geographic area, which includes the destination from the geographical area database. The predetermined geographic area that includes the destination can be referred to as the “destination area.” The shipment coordination service 420 can select a destination carrier from the list of carriers associated with the destination area. In some embodiment, the shipment coordination service 420 can determine a destination processing center or delivery center associated with the destination area.

The destination carrier may be selected based on a number of factors, such as the destination address, the service selected by the customer (e.g., express or regular), size and weight of the package, rates offered by the destination carrier, and other factors. The shipment coordination service 420 may automatically select the destination carrier based on the customer input. The shipment coordination service 420 can select the destination carrier during the transaction or any time before the transaction is completed. The shipment coordination service 420 may not communicate the identity of the destination carrier to the user until the transaction is complete. The shipment coordination service 420 may communicate with the destination carrier interface to obtain an identification code assigned to the shipment by the destination carrier. The identification code assigned by the destination carrier can be referred to as “destination carrier tracking code.” In some embodiments, the shipment coordination service 420 may not select a destination carrier 107 during the transaction, and the destination carrier 107 can be determined at a later point in time, such as after the package is delivered at the origin area processing center 140 by the origin carrier 105.

The shipment coordination service 420 can select a combination of origin carrier and destination carrier that can optimize the delivery speed or other requirements for the shipment. In some embodiments, the shipment coordination service 420 may select a processing center that can help to optimize the delivery speed or other requirements for the shipment. For example, if an origin area includes two or more processing centers, the shipment coordination service 420 can choose the processing center (such as one located closest to the airport) that can provide the shortest delivery time for the shipment.

At block 810, the computing shipment coordination service 420 can generate a label including shipping information for shipment of the package. The label can include information for shipping the package from the origin to the destination. The label can include information relating to the origin carrier, the destination carrier and the origin area processing center. During or after completion of the transaction, the shipment coordination service 420 can generate a label that includes information relating to the origin shipment and information relating to the destination shipment. Information relating to the origin shipment can be referred to as the origin shipment information. Information relating to the destination shipment can be referred to as the destination shipment information. The user can print and attach the label onto the package for delivery by the origin carrier.

### Shipment Processing by Processing Center

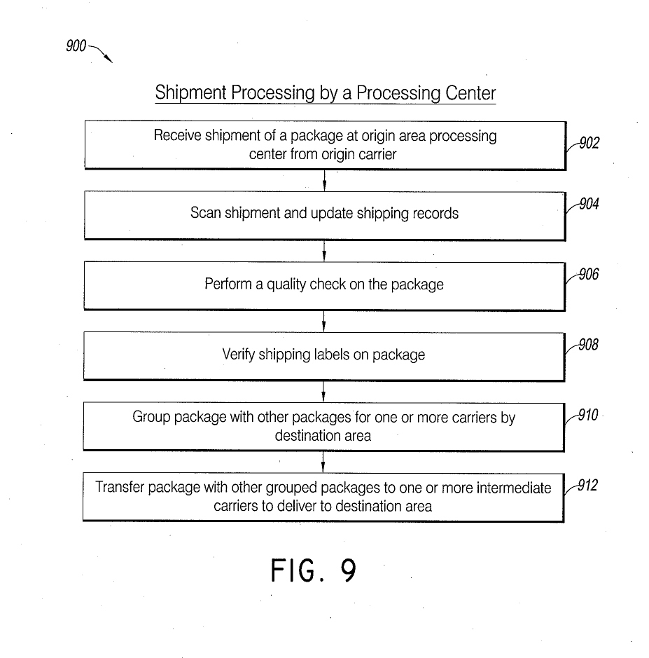

FIG. 9 illustrates a flowchart of a process 900 for processing a shipment of a package arranged by a shipment coordination service between an origin and a destination by a processing center. The process 900 is explained with respect to a processing center 140 in FIG. 1 for illustrative purposes, but the process 900 can be implemented by any other system as appropriate. The process 900 is shown to include certain blocks in FIG. 9, but one or more blocks can be omitted and additional blocks can be added depending on the embodiment. The blocks of the process 900 can also be performed in an order different from the order shown in FIG. 9.

At block 902, the origin processing center receives a package from the origin carrier. The label provided by the shipment coordination service 420 can provide delivery instructions for the origin shipment from the origin to the origin processing center. In some embodiments, the instructions can be encoded into the label printed by the user. The instructions can include the origin carrier identification code. The origin carrier 105 may identify the package by referring to the origin carrier identification code and/or the origin shipment information in the label. For example, the origin carrier can scan a barcode associated with the origin carrier on the label. The shipment coordination service 420 may update the status of the shipment based on the tracking information available from the origin carrier 105.

At block 904, the origin area processing center processes the delivered package by scanning the label on the package and update shipping records associated with the package. The package can be identified by the unique transaction identification code. In some embodiments, the package may be identified by the origin carrier tracking code. The unique transaction identification code or the origin carrier tracking code may be in the form of a barcode on the label, and the origin area processing center may scan the barcode to identify the package. The shipment coordination service 420 can update the status of the shipment to reflect that the package has been received at the origin area processing center.

At block 906, the origin area processing center may perform a quality check of the package. The quality check can include verifying the weight and size of the package. If the actual weight and size of the package does not match the information entered by the customer and the actual payment is less than the actual cost, the origin area processing center may initiate a process for requesting additional payment from the user or returning the package.

At block 908, the processing center can verify the shipping labels. The processing center can verify that the correct shipping labels are on the package and check the physical integrity of the labels. If for any reason any part of the label is not legible and unclear, the origin area processing center can reprint a portion or the entire label and attach it onto the package. If the label attached by the customer does not include the destination shipment information, the origin area processing center can print a label with the destination shipment information and attach it onto the package. If the label attached by the customer does not include the intermediate shipment information, the origin area processing center can print a label with the intermediate shipment information and attach it to the package. The origin area processing center may print one label containing both the destination shipment information and the intermediate shipment information. In some embodiments, the processing center 140 can add an electronic label to the package. The electronic label can be used for processing, tracking and shipment of the package. The electronic label can use radio frequency identification (RFID) technology, or other technology for wirelessly communicating information from the label to a scanning device. The electronic label can supplement information included on a printed label. The electronic label can include information associated with the package, such as the information stored in the shipment data store, the package data store, and/or a portion of the data stored thereof. The electronic label can store confidential information. For example, the electronic label could store package contents information.

The electronic label can be associated with the shipment coordination service 420 and used by each of the plurality of carriers. In some embodiments, a customer can purchase the label and load the information onto the label prior to shipping the package. In some embodiments, the electronic label can communicate information associated with a segment of the overall shipment. For example, the electronic label can communicate information specific to a carrier identification code. In this manner, only a portion of the information stored on the label could be communicated to each carrier.

The origin area processing center can receive additional packages from one or more origin carriers from one or more predetermined geographic areas. Each package may have a label that includes a unique identification code assigned by the respective origin carrier. The unique identification code may be associated with the shipment of the package from a location within the origin area to the origin area processing center.

At block 910, the processing center groups the package with other packages by destination area. The origin area processing center can sort and group the packages received by destination area. In one embodiment, the destination area is a country, and the packages to be delivered to destinations in the country are grouped together and packaged together. For example, packages for the same destination area may be packed onto one or more pallets for loading and unloading. If packages are to be delivered by one or more destination carriers in the destination area, the packages may be further grouped by destination carrier.

At block 912, the processing center transfers the grouped packages to one or more intermediate carriers to deliver to the destination area. The intermediate carrier may have an intermediate location to which the company can deliver the packages. In one embodiment, an intermediate carrier is an airline. The airline may transport the packages on a passenger plane or a cargo plane. If the packages are packed on pallets, the airline can load and unload the pallets for delivery to the destination area. The intermediate carrier may be determined at the time of delivery of the package to the processing center.

The package is delivered to the destination area by the intermediate carriers. In some embodiments, the package is delivered to a destination processing center. The destination processing center can process and route the packages to a specific destination carrier. In some embodiments, the packages are delivered to a destination carrier staging or processing area where they are processed by the destination carrier.

### International Shipments

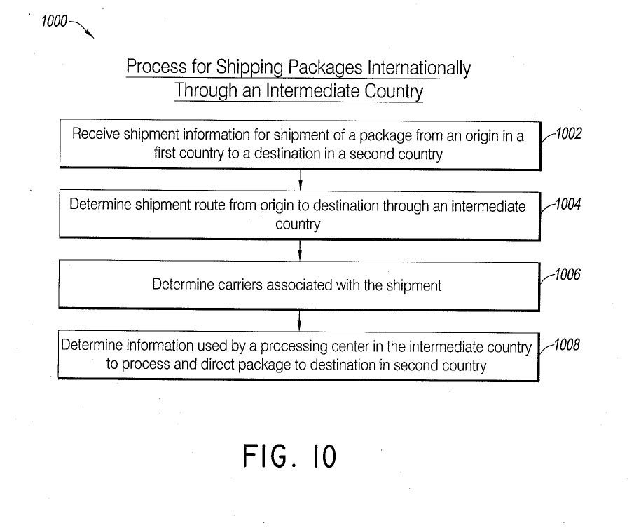

FIG. 10 illustrates a flowchart of a process 1000 for coordinating shipment of a package internationally between an origin and a destination using one or more carriers. The process 800 is shown to include certain blocks in FIG. 10, but one or more blocks can be omitted and additional blocks can be added depending on the embodiment.

At block 1002, the shipment coordination service 420 receives information for the shipment of a package from a first country to a second country. The information received by the shipment coordination service 420 from a user includes at least an origin located in the first country and a destination located in the second country. The information received by the shipment coordination service 420 can also include, but is not limited to, number of packages, package information, type and level of service, time frame, and other information associated with the shipment of the package from the origin to the destination.

At block 1004, the shipment coordination service 420 can determine a route for the shipment from the origin to the destination including at least one intermediate country. The intermediate country may not be origin country or the destination country. The intermediate destination country can be selected for processing the package prior to shipment to the destination country. The shipment route can be determined based on information received from the customs module 430 and international shipping information stored in a customs/tariff data store, such as countries that are members of the Universal Postal Union (“UPU”), and other information that can be used to help determine how to route international packages.

For example, the packages sent directly from the first country to the second country may take longer and/or cost more than shipping the same package to an intermediate country, which processes and redirects the package to the destination country. The package can be received by the intermediate country, processed and redirected to the destination country. During the processing by the intermediate country, an additional label, such as an Express Mail Service (“EMS”) label can be affixed to the package, which can then be redirected to the destination country.

At block 1006, the shipment coordination service 420 can select carriers for the shipment. The shipment coordination service can select the origin carrier and origin processing center as described above in association with FIG. 8. The shipment coordination service 420 can select an intermediate country processing center for processing the package prior to delivery. The intermediate country processing center can deliver the package to the destination country and select a destination carrier for delivering the package to the destination.

At block 1008, the shipment coordination system 420 determines the information used by the intermediate country processing center to process and direct the package to the destination in the destination country. In some embodiment, the shipment coordination service 420 generates a label that is affixed by the sender of the package that contains the information used by the intermediate country processing center. In some embodiments, the origin processing center affixes the label for use by the intermediate country processing center.

### Shipment Tracking

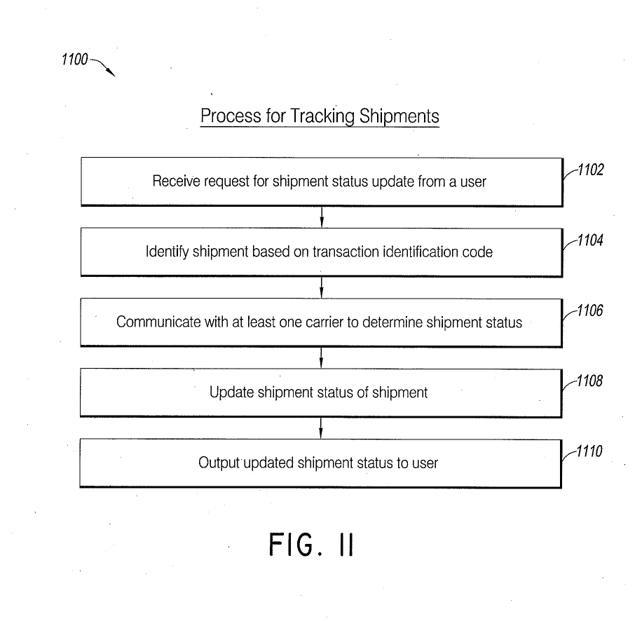

FIG. 11 illustrates a flowchart of a process 1100 for tracking shipments of a package between an origin and a destination using a plurality of carriers. The process 1100 is shown to include certain blocks in FIG. 11, but one or more blocks can be omitted and additional blocks can be added depending on the embodiment. In an exemplary embodiment the tracking module 432 can implement the process 1100.

At block 1102 the shipment coordination service receives a request for a shipment status update at a user interface for tracking shipments provided by the shipment coordination service. The request includes the unique transaction identification code associated with the shipment.

At block 1104, the tracking module uses the unique transaction identification code to identify the shipment within a shipment data store. The tracking module can determine, based on unique transaction identification code, the carrier specific tracking information associated with each of the plurality of carriers. In some embodiments, the tracking module can identify the most recent status update for the package and determine which segments have already been completed. The tracking module can identify the carrier specific tracking information for a subset of the carriers, for which the segments have not yet been completed.

At block 1106, based on the carrier specific tracking information in the shipment data store, the tracking module communicates with one or more carriers to determine the current status of the shipment. The carrier specific tracking information can include a carrier specific tracking code. The tracking module can communicate with the carrier through the carrier's tracking interface. The tracking module retrieves the updated shipment information from one or more carriers.

At block 1108, the shipment status of the shipment is updated. The tracking module can update the data entry associated with the unique identification number in the shipment data store. At block 1110, the system provides an output to the user that provides the current status of the shipment to the user. The output can also provide information associated with the previous segments of the shipments, such as delivery dates and times. The process can be completed as a real-time transaction and provided to the user without substantial delay. For example, the user can submit the request to the system and receive an updated shipping status within the user interface.

### Shipping Packages Using Electronic Labels

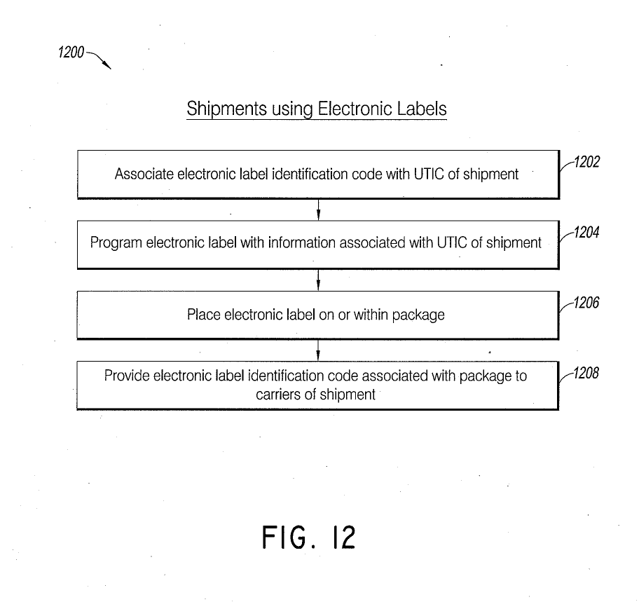

FIG. 12 illustrates a flowchart of a process 1200 for shipments using electronic labels. The process 1200 is shown to include certain blocks in FIG. 12, but one or more blocks can be omitted and additional blocks can be added depending on the embodiment.

At block 1202, the identification code of the electronic label is associated with the unique tracking identification code (UTIC) of the shipment. The electronic label can be used for processing, tracking and shipment of the package. The electronic label can have a unique identification code that uses a specific alphanumeric sequence or other identifier readable by a computing device that can be used to identify the specific label. The electronic label can be a label that uses RFID technology, or other technology capable of wirelessly communicating information from the label to a computing device. The label's identification code can be associated with the UTIC during the initial transaction by the user with the shipment coordination service. For example, a user could acquire an electronic label for use during the shipment. In some embodiments, the electronic label can be associated with the shipment after the package has been received by a processing center.

At block 1204, the electronic label is programmed to include information associated with the UTIC of the shipment. The electronic label can supplement information included on a printed label. Information can include any information associated with the package, including information stored in data stores associated with the shipment, such as the shipment data store, the package data store and/or portions of the data stored thereon. The electronic label can store information that would not be desirable to be printed on a package label, such as package contents, value, confidential information and other information. In some embodiments, the label can include carrier specific information.

At block 1206, the electronic label is placed on or within the package. In some embodiments, the label can be affixed to the outside of the package, whereas in other embodiments the electronic label can be placed within the package. The electronic label can be configured such that it can function regardless of its positioning within or on the package.

At block 1208, the electronic label identification code associated with the package is provided to the carriers of the shipment. The carriers can use the electronic label identification code to scan and process the shipment. In some embodiments, the carriers can read information from and write information to the electronic label. For example, a carrier may update the shipment status on the electronic label. In some embodiments, the electronic label can communicate carrier specific information associated with the carrier's segment of the overall shipment. In this manner, only a portion of the information stored on the label could be communicated to each carrier.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules and algorithm elements described in connection with the embodiments disclosed herein can be implemented as electronic hardware, computer software or combinations of both. To clearly illustrate this interchangeability of hardware and software, various illustrative components, blocks, modules and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM or any other form of non-transitory computer-readable storage medium, media or physical computer storage known in the art. An example storage medium can be coupled to the processor such that the processor can read information from, and write information to, the storage medium. In the alternative, the storage medium can be integral to the processor. The storage medium can be volatile or nonvolatile. The processor and the storage medium can reside in an ASIC. The ASIC can reside in a user terminal. In the alternative, the processor and the storage medium can reside as discrete components in a user terminal.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

1. A method of coordinating and processing shipment of a package by a business between an origin to a destination, the method comprising:
providing a data store comprising geographical area data store entries associated with a plurality of predetermined geographical areas and carrier data store entries associated with a plurality of carriers;
providing a user interface on a computing device for a customer to conduct a transaction for shipment of a package from an origin to a destination;
receiving shipment information from the customer through the user interface, wherein the shipment information comprises the origin and the destination;
identifying a first predetermined geographical area encompassing the origin, wherein the first predetermined geographical area is one of the plurality of predetermined geographical areas;
identifying an origin processing center located within the first predetermined geographical area;
identifying a second predetermined geographical area encompassing the destination, wherein the second predetermined geographical area is one of the plurality of predetermined geographical areas;
determining a shipment route from the origin to the destination, wherein the shipment route comprises:
an origin shipment segment for delivery of the package from the origin to an origin processing center;
an intermediate shipment segment for delivery of the package from the origin processing center to an intermediate destination using an intermediate carrier, and
a destination shipment segment for delivery of the package from the intermediate destination to the destination;
selecting an origin carrier for the origin shipment segment, wherein the origin carrier is selected from a first group of carriers that are associated with the first predetermined geographical area;
selecting a destination carrier for the destination shipment segment, wherein the destination carrier is selected from a second group of carriers that are associated with the second predetermined geographical area, wherein the intermediate carrier is a different carrier than the origin carrier and the destination carrier;
assigning an origin carrier identification code associated with the origin carrier for the origin shipment segment such that the origin carrier uses the origin carrier identification code to identify the package for the origin shipment segment;
assigning a destination carrier identification code associated with the destination carrier for the destination shipment segment such that the destination carrier uses the destination carrier identification code to identify the package for the destination shipment segment;
assigning an overall shipment identification code for the transaction for shipment of the package from the origin to the destination, wherein the overall shipment identification code is different from the origin carrier identification code and also different from the destination carrier identification code;
generating a label for attaching onto the package, the label comprising,
the overall shipment identification code,
an origin shipment portion for use by the origin carrier during the origin shipment segment, the origin shipment portion including the origin carrier identification code and an address of the origin processing center as a destination of the origin shipment segment for the origin carrier, and
a destination shipment portion for use by the destination carrier during the destination shipment segment, the destination shipment portion including the destination carrier identification code and an address for the destination;
subsequently, receiving the package at the origin area processing center delivered by the origin carrier with the use of the address of the origin processing center appearing on the label attached to the package;
packing, at the origin processing center, the package on a pallet with other packages for shipment of the intermediate shipment segment in pallet; and
causing to send, from the origin processing center, the pallet for shipment of the package to the intermediate destination in pallet,
wherein packing and shipment of the package in pallet to the intermediate destination occurs after the completion of the origin shipment segment to the origin processing center enabled by the address of the origin processing center appearing in the origin shipment portion of the label.

2. The method of claim 1, further comprising creating a shipment data store entry for the transaction, the shipment data store entry comprising the shipment identification code, the origin carrier identification code, the destination carrier identification code, information indicative of the origin carrier, and information indicative of the destination carrier, wherein assigning the origin carrier identification code comprises communicating with a system interface of the origin carrier, and wherein assigning the destination carrier identification code comprises communicating with a system interface of the destination carrier.

3. The method of claim 1, wherein the steps of identifying a first predetermined geographical area, identifying an origin processing center, identifying a second predetermined geographical area, determining a shipment route, selecting an origin carrier, selecting a destination carrier, assigning an origin carrier identification code, assigning a destination carrier identification code and assigning a shipment identification code are performed real time while the customer is conducting the transaction using the user interface.

4. The method of claim 3, further comprises:
formulating details of the shipment of the package from the origin to the destination; and
sending the details to the computing device for presenting to the customer using the user interface,
wherein a plurality of steps among identifying a first predetermined geographical area, identifying an origin processing center, identifying a second predetermined geographical area, determining a shipment route, selecting an origin carrier, selecting a destination carrier, assigning an origin carrier identification code, assigning a destination carrier identification code, assigning a shipment identification code, generating a label, formulating details and sending the details are performed real time while the customer is conducting the transaction using the user interface.

5. The method of claim 1, further comprising:
receiving a request, from a user, for a status update of the shipment of the package, the request comprising the shipment identification code;
identifying the origin carrier identification code and the destination carrier identification code based on the shipment identification code,
based on a current status of the shipment, performing at least one of the following:
communicating with the origin carrier to request an origin carrier shipment status using the origin carrier identification code;
communicating with the processing center to request a processing center shipment status using the shipment identification code;
communicating with the destination carrier to request a destination carrier shipment status using the destination carrier identification code;
providing the status update, in substantially real-time, to the user comprising information from at least one of the origin carrier shipment status, the processing center shipment status, and the destination shipment status.

6. The method of claim 1, wherein the origin carrier is operated by a first entity, the origin processing center is operated by a second entity, and the destination carrier is operated by a third entity.

7. The method of claim 1, wherein the origin carrier is operated by a first entity, the origin processing center is operated by a second entity, and the destination carrier is operated by the first entity.

8. The method of claim 1, wherein the origin is in a first country and the destination is in a second country, and wherein determining the shipment route from the origin to the destination further comprises determining a third country for the shipment route based on the second country, wherein the intermediate destination is the third country.

9. The method of claim 1, wherein the label is generated in substantially real-time during the transaction, wherein the label is in the form of a single sheet.

10. The method of claim 1, further comprising:
before or at completion of the transaction, providing the customer with an identity of the origin carrier, the label for the customer or an agent of the origin carrier to print for the package, and instructions for transferring the package to the origin carrier,
wherein when the package is to be picked up, the instructions specify time and the pick-up location along with the identity of the origin carrier, wherein when the package is to be dropped off, the instructions provide the identity of the origin carrier and one or more drop-off locations for the origin carrier.

11. The method of claim 1, wherein the intermediate location is a destination area processing center, wherein the origin processing center is located adjacent to a port, airport or train station for shipment therefrom by ship, air or train.

12. A system for coordinating and processing shipment of a package between an origin to a destination, the system comprising a data store, a shipment coordination system, and an origin processing center:
the data store comprising geographical area data store entries associated with a plurality of predetermined geographical areas, carrier data store entries associated with a plurality of carriers, and shipment data store entries associated with shipment transactions;
the shipment coordination system in communication with the data store comprising a hardware computing device with executable instructions configured:
to receive shipment information comprising an origin and a destination;
to identify a first predetermined geographical area based, at least in part, on the origin, wherein the first predetermined geographical area is one of the plurality of predetermined geographical areas, wherein the origin processing center is located within the first predetermined geographical area;
to identify a second predetermined geographical area based, at least in part, on the destination, wherein the second predetermined geographical area is one of the plurality of predetermined geographical areas;
to determine a shipment route from the origin to the destination, wherein the shipment route comprises:
an origin shipment segment for delivery of the package from the origin to an origin processing center;
an intermediate shipment segment for delivery of the package from the origin processing center to an intermediate destination using an intermediate carrier, and
a destination shipment segment for delivery of the package from the intermediate destination to the destination;
to select an origin carrier for the origin shipment segment, wherein the origin carrier is selected from a first group of carriers associated with the first predetermined geographical area;
to select a destination carrier for the destination shipment segment, wherein the destination carrier is selected from a second group of carriers associated with the second predetermined geographical area, wherein the intermediate carrier is a different carrier than the origin carrier and the destination carrier;
to assign an origin carrier identification code associated with the origin carrier to the origin shipment segment, wherein assigning the origin carrier identification code comprises communicating with an origin carrier interface such that the origin carrier uses the origin carrier identification code to identify the package for the origin shipment segment;
to assign a destination carrier identification code associated with the destination carrier to the destination shipment segment, wherein assigning the destination carrier identification code comprises communicating with destination carrier interface such that the destination carrier uses the destination carrier identification code to identify the package for the destination shipment segment;
to assign an overall shipment identification code for the transaction for shipment of the package from the origin to the destination, wherein the overall shipment identification code is different from the origin carrier identification code and also different from the destination carrier identification code; and
to generate a label for attaching onto the package,
wherein the label comprises:
a transaction information portion including the overall shipment identification code,
an origin shipment portion for use by the origin carrier during the origin shipment segment, the origin shipment portion including the origin carrier identification code and an address of the origin processing center as a destination of the origin shipment segment for the origin carrier, and
a destination shipment portion for use by the destination carrier during the destination shipment segment, the destination shipment portion including the destination carrier identification code and an address for the destination;
wherein the origin processing center is configured:
to receive package from the origin carrier with the label attached to the package,
to scan the label for identifying the package at the origin processing center,
to pack the package on a pallet with other packages, and
to send the pallet for shipment of the package in pallet to the intermediate destination such that shipment in pallet occurs after completion of the origin shipment segment to the origin processing center enabled by the address of the origin processing center appearing in the origin shipment portion of the label.

13. The system of claim 12, wherein the shipment coordination service is further configure to create a shipment database entry for the transaction, the shipment data store entry comprising the shipment identification code, the origin carrier identification code, the destination carrier identification code, information indicative of the origin carrier, and information indicative of the destination carrier
wherein the shipment coordination system is configured to execute a plurality of instruction configured to identify a first predetermined geographical area, identify an origin processing center, identify a second predetermined geographical area, determine a shipment route, select an origin carrier, select a destination carrier, assign an origin carrier identification code, assign a destination carrier identification code, assign a shipment identification code, generate a label.

14. The system of claim 12, wherein the shipment coordination service is further configured to:
receive a request, from a user, for a status update of the shipment of the package, the request comprising the shipment identification code;
identify the origin carrier identification code and the destination carrier identification code based on the shipment identification code,
based on a current status of the shipment, performing at least one of the following:
communicate with the origin carrier to request an origin carrier shipment status using the origin carrier identification code;
communicate with the processing center to request a processing center shipment status using the shipment identification code;
communicate with the destination carrier to request a destination carrier shipment status using the destination carrier identification code;
providing the status update to the user comprising information from at least one of the origin carrier shipment status, the processing center shipment status, and the destination shipment status.

15. The system of claim 12, wherein the shipment coordination system and the processing center are operated by the same entity which is a different entity than the origin carrier and the destination carrier.

16. The system of claim 12, wherein the shipment information further comprises at least one of package type, package weight, package size, package value, and service type.

17. The system of claim 12, wherein the origin is in a first country and the destination is a second country, and wherein the shipment coordination service is further configured to determine a third country that the packaged is to be shipped through for at least one of the intermediate shipment segments based, at least in part, on the second country.

18. (canceled)

19. The system of claim 12, wherein the each of the plurality of predetermined geographic areas are defined by at least one of a country, state, city, county or arbitrary boundary.

20. The method of claim 12, wherein the label is generated in substantially real-time during the transaction, wherein the label is in the form of a single sheet.

21. A method of coordinating and processing an international shipment of a package between an origin to a destination, the method comprising:
providing a data store comprising geographical area data store entries associated with a plurality of predetermined geographical areas and carrier data store entries associated with a plurality of carriers;
providing a user interface on a computing device for a customer to conduct a transaction for shipment of a package from an origin to a destination;
receiving shipment information from the customer through the user interface, wherein the shipment information comprises the origin in a first country and the destination in a second country;
identifying a first predetermined geographical area encompassing the origin, wherein the first predetermined geographical area is one of the plurality of predetermined geographical areas;
identifying an origin processing center located within first predetermined geographical area;
identifying a second predetermined geographical area encompassing the destination, wherein the second predetermined geographical area is one of the plurality of predetermined geographical areas;
determining a shipment route from the origin to the destination, wherein the shipment route comprises:
an origin shipment segment for delivery of the package from the origin to an origin processing center in the first country;
at least one intermediate shipment segment for delivery of the package from the origin processing center to an intermediate destination in a third country, and
a destination shipment segment for delivery of the package from the intermediate destination in the third country to the destination in the second country;
selecting an origin carrier for the origin shipment segment, an intermediate carrier for the intermediate shipment segment, and a destination carrier for the destination shipment;
wherein the origin carrier is selected from a first group of carriers that are associated with the first predetermined geographical area, wherein the intermediate carrier is a different carrier than the origin carrier and the destination carrier;
assigning an origin carrier identification code associated with the origin carrier for the origin shipment segment, wherein assigning the origin carrier identification code comprises communicating with an origin carrier interface such that the origin carrier uses the origin carrier identification code to identify the package for the origin shipment segment;
assigning an overall shipment identification code for the transaction for shipment of the package from the origin to the destination, wherein the overall shipment identification code is different from the origin carrier identification code; and
generating a label for attaching onto the package, the label comprising,
the overall shipment identification code and an address for the destination; and
an origin shipment portion for use by the origin carrier during the origin shipment segment, the origin shipment portion including the origin carrier identification code and an address of the origin processing center as a destination of the origin shipment segment for the origin carrier;
subsequently receiving the package at the origin processing center delivered by the origin carrier with the use of the address of the origin processing center appearing on the label attached to the package;
scanning the package at the origin processing center, wherein the shipment identification code is used by the origin processing center for identifying the package at the origin processing center;
packing, at the origin processing center, the package on a pallet with other packages for shipment of the intermediate shipment segment in pallet; and
causing to send, from the origin processing center, the pallet for delivery to the intermediate destination in the third country where the intermediate carrier's delivery responsibility terminates,
wherein packing and shipment of the package in pallet to the intermediate destination in the third country occurs after the completion of the origin shipment segment to the origin processing center enabled by the address of the origin processing center appearing in the origin shipment portion of the label.

22. The method of claim 21, wherein the identification of the third country is determined based, at least in part, on the second country.

23. The method of claim 21, further comprising identifying an international carrier for delivering the package from the intermediate destination in the third country to the destination in the second country.

24. The method of claim 23, further comprising creating a shipment data store entry for the transaction, the shipment data store entry comprising the shipment identification code, the origin carrier identification code, information indicative of the origin carrier, and information indicative of an international carrier.

25. The method of claim 21, further comprises:
formulating details of the shipment of the package from the origin to the destination; and
sending the details to the computing device for presenting to the customer using the user interface,
wherein a plurality of steps among identifying a first predetermined geographical area, identifying an origin processing center, identifying a second predetermined geographical area, determining a shipment route, selecting an origin carrier, assigning an origin carrier identification code, assigning a shipment identification code, generating a label, formulating details and sending the details are performed real time while the customer is conducting the transaction using the user interface.

26. The method of claim 21, further comprising:
receiving a request, from a user, for a status update of the shipment of the package, the request comprising the shipment identification code;
identifying the origin carrier identification code based on the shipment identification code,
based on a current status of the shipment, performing at least one of the following:
communicating with the origin carrier to request an origin carrier shipment status using the origin carrier identification code;
communicating with the processing center to request a processing center shipment status using the shipment identification code;
communicating with the international carrier to request an international carrier shipment status; and
providing the status update, in substantially real-time, to the user comprising information from at least one of the origin carrier shipment status, the processing center shipment status, and the international carrier shipment status.

27. (canceled)

28. The system of claim 21, wherein the shipment information further comprises at least one of package type, package weight, package size, package value, service type, and customs information.

29. The system of claim 21, wherein the each of the plurality of predetermined geographic areas are defined by at least one of a country, state, city, county or arbitrary boundary.

30. The method of claim 21, wherein the origin carrier is operated by a first entity, the processing center is operated by a different second entity.

31. The method of claim 1, wherein the origin processing center is located within the first predetermined geographical area.

32. The method of claim 1, wherein assigning the origin carrier identification code comprises a first communication with the origin carrier, wherein assigning the destination carrier identification code comprises a second communication with the destination carrier that is separate from the first communication.
